(19) United States
(12) Patent Application Publication
(10) Pub. No.: US 2009/0094170 A1
(43) Pub. Date: Apr. 9, 2009

(54) METHODS AND SYSTEMS FOR FINANCIAL ACCOUNT MANAGEMENT

(76) Inventor: Anne Mercier Mohn, Cambridge, MA (US)

Correspondence Address: Anne Mercier Mohn, Financial Impact Advisors, Inc., PO Box 380326, Cambridge, MA, 02238, US

(21) Appl. No.: 12/249,041

(22) Filed: Oct. 10, 2008

Related U.S. Application Data
(63) Continuation of application No. 11/316,679, filed on Dec. 22, 2005, now abandoned.
(60) Provisional application No. 60/713,695, filed on Sep. 2, 2005.

(51) Int. Cl. G06Q 40/00

(52) U.S. Cl. 705/36 T; 705/36 R

(57) ABSTRACT

Provided herein are methods and systems for managing a plurality of investment accounts, allowing the automatic execution of financial plans.

### CROSS-REFERENCE TO RELATED APPLICATIONS

The present application is a continuation of U.S. patent application Ser. No. 11/316,679 filed on Dec. 22, 2005 and entitled, “Methods and Systems for Financial Account Management,” which claims priority to U.S. Provisional Application No. 60/713,695, filed on Sep. 21, 2005 and entitled “Financial Account Management.” These references are hereby incorporated herein by reference in their entireties.

### BACKGROUND

1. Field of the Invention

This invention relates to the field of financial services, and more particularly to the automatic management of assets.

2. Description of the Related Art

People in the United States of America are experiencing increasing personal financial pressures due to higher-education costs, reduced company-retirement plans, skyrocketing healthcare costs, stagnant wages, and the like. As a result, financial services relating to planning for retirement and other major life events are becoming more important. Vehicles exist for accumulating retirement income, such as 401(k) accounts, various forms of Individual Retirement Accounts (IRAs) and the like, some of which are tax-favored. However, the increased flexibility provided by the proliferation of new retirement vehicles has been accompanied by the increased complexity of retirement planning. A need exists for retirement vehicles that (1) improve the ability of individuals to execute financial plans directed toward retirement and major life events and (2) that improve the ability of financial institutions to deliver related services to individuals.

### SUMMARY

Provided herein are methods and systems for managing a plurality of investment accounts, allowing the automatic execution of financial plans. The methods and systems include methods and systems for providing an automatic management of a plurality of accounts that relate to planning for the financial needs of a phase of life or a major life event, wherein the automatic management suggests, recommends, and/or executes transfers among the plurality of accounts in order to enforce asset allocation rules, which may embody an investment strategy that may incorporate individual investment preferences, asset investment-performance metrics, financial advisor inputs, regulatory information, and so forth.

The methods and systems disclosed herein include methods and systems for handling financial assets designated by an entity. The methods and systems may include taking a first asset facility designated by the entity, taking a second asset facility designated by the entity, and allocating a financial asset among the first asset facility and the second asset facility based on a condition, where the first asset facility and the second asset facility are maintained by separate financial institutions. In embodiments the condition may be set via a set via a Web browser, which may utilize a plug-in, toolbar, the Ajax programming methodology, Greasemonkey, or a JavaScript interpreter. The Web browser may exist on a mobile facility, which may utilize a J2ME engine and/or may comprise a cell phone, Blackberry, or personal digital assistant. The Web browser, whether or not incorporated into the mobile facility, may be utilized to perform the allocating of the financial asset. In embodiments, the first asset facility may be any kind of facility for holding financial assets, such as an account, or another facility such as ATM account; an accumulation account; a miscellaneous cash transfer account; a temporary cash holding account; a cash accumulation account; a checking account; a debit account; a certificate of deposit; a savings account; a passbook savings account; insured by the FDIC; linked to the second asset facility by home-link banking software; a mutual fund account; a stock account; a bond account; a combined stock and bond account; a brokerage account; a brokerage investment account; a brokerage wrap account; a brokerage core account; a whole life insurance policy; a paid-up life insurance policy; a term life insurance policy; a variable annuity insurance policy; an asset allocation investment account; a lifecycle investment account; an index fund investment account; a money market investment account; an account related to a premarital agreement; an account related to a post-marital agreement; an account related to a living-together agreement; an account related to a frequent flier miles account; an account related to a hotel rewards account; an account related to a car rental rewards account; or an account related to a rebate accumulation account. Likewise in embodiments, the second asset facility may be any kind of facility for holding financial assets, such as an account, or another facility such as an education IRA savings account; an IRC §529 education savings account; a post-secondary school savings account; a 401(k) account; a 403(b) account; a 412(b) account; a retirement savings account; a target date retirement savings account; a trust; a charitable account; an investment account used in the estate planning process; a by-pass trust account; a family trust account; a qualified terminable interest account; a life insurance trust account; a generation skipping trust; a uniform trusts for minors account; a uniform gifts to minors account; a Crummey trust account; a sprinkling trust account; a special needs trust account; a revocable trust account; an irrevocable trust account; a grantor retained annuity trust account; an investment account that is the source of trust principal; a charitable remainder annuity trust; a charitable remainder unitrust; a pooled incoming find account; a charitable lead trust account; a charitable lead unitrust account; or related to a social security privatization savings account. The second asset facility may change from time to time due to changes in federal and/or state tax laws. In embodiments, the allocating of the financial asset may be based on the on the output of an analysis facility, which may take into account an asset parameter, an advisor parameter, a risk parameter, a financial parameter, and/or a compliance parameter.

The methods and systems disclosed herein include methods and systems for handling financial assets designated by an entity. The methods and systems may include taking a first asset facility designated by the entity, taking a second asset facility designated by the entity, and allocating a financial asset among the first asset facility and the second asset facility based on a condition. In embodiments, the condition may be set via a communications network; a data feed; a server; a client; and/or a Web browser. The Web browser may utilize a plug-in, a toolbar, the Ajax programming methodology, Greasemonkey, and/or a JavaScript interpreter. The Web browser may exist on a mobile facility, which may utilize a J2ME engine and/or may comprise a cell phone, Blackberry, or personal digital assistant. The condition may be set via the mobile facility. The allocating of the financial asset may be performed via the communications network; the data feed; the server; the client; and/or the Web browser, regardless of whether the Web browser is contained in the mobile facility.

The methods and systems disclosed herein include methods and systems for handling financial assets designated by an entity. The methods and systems may include taking a first asset facility designated by the entity, taking a second asset facility designated by the entity, and allocating a financial asset among the first asset facility and the second asset facility based on a condition. In embodiments, the first asset facility may be any kind of tax-aware facility for holding financial assets, such as an account, or another facility such as ATM account; an accumulation account; a miscellaneous cash transfer account; a temporary cash holding account; a cash accumulation account; a checking account; a debit account; a certificate of deposit; a savings account; a passbook savings account; insured by the FDIC; linked to the second asset facility by home-link banking software; a mutual fund account; a stock account; a bond account; a combined stock and bond account; a brokerage account; a brokerage investment account; a brokerage wrap account; a brokerage core account; a whole life insurance policy; a paid-up life insurance policy; a term life insurance policy; a variable annuity insurance policy; an asset allocation investment account; a lifecycle investment account; an index fund investment account; a money market investment account; an account related to a premarital agreement; an account related to a post-marital agreement; an account related to a living-together agreement; an account related to a frequent flier miles account; an account related to a hotel rewards account; an account related to a car rental rewards account; or an account related to a rebate accumulation account. Likewise, in embodiments, the second asset facility may be any kind of tax-advantaged facility for holding financial assets, such as an account, or another facility such as an education IRA savings account; an IRC §529 education savings account; a post-secondary school savings account; a 401(k) account; a 403(b) account; a 412(b) account; a retirement savings account; a target date retirement savings account; a trust; a charitable account; an investment account used in the estate planning process; a by-pass trust account; a family trust account; a qualified terminable interest account; a life insurance trust account; a generation skipping trust; a uniform trusts for minors account; a uniform gifts to minors account; a Crummey trust account; a sprinkling trust account; a special needs trust account; a revocable trust account; an irrevocable trust account; a grantor retained annuity trust account; an investment account that is the source of trust principal; a charitable remainder annuity trust; a charitable remainder unitrust; a pooled incoming fund account; a charitable lead trust account; a is a charitable lead unitrust account; or an account related to a social security privatization savings account. The second asset facility may change from time to time due to changes in federal and/or state tax laws.

The methods and systems disclosed herein include methods and system for handling financial assets designated by an entity. The methods and systems may include taking a first asset facility designated by the entity, taking a second asset facility designated by the entity, and allocating a financial asset among the first asset facility and the second asset facility based on a condition. In certain optional embodiments, the allocation may be enabled by an asset transaction facility. In embodiments, the allocating of the financial asset may be based on the output of an analysis facility, which may take into account one or more of an asset parameter, an advisor parameter, a risk parameter, a financial parameter, and a compliance parameter. Likewise, in embodiments, the first asset facility and the second asset facility may be maintained at separate financial institutions; the entity may be a trust or an individual; and/or one of the asset facilities may be a tax-aware account while the other of the asset facilities may be a tax-favored account.

The methods and systems disclosed herein include methods and systems for handling financial assets designated by an entity. The methods and systems may include methods and systems for taking a first asset facility designated by the entity, taking a second asset facility designated by the entity, and allocating a financial asset among the first asset facility and the second asset facility based on a condition, where the first asset facility and the second asset facility are maintained by separate financial institutions. In embodiments the first asset facility and the second asset facility may be a pair of any kind of facilities for holding financial assets, such as a first account and a second account, or another pair of facilities such as a savings account and an IRA savings account; a savings account and an IRC §529 education savings account; a savings account and a 401(k) account; a savings account and a 403(b) account; a savings account and a 412(b) account; a savings account and a trust; a savings account and a social security privatization savings account; a temporary cash holding account and an IRA savings account; a temporary cash holding account and an IRC §529 education savings account; a temporary cash holding account and a 401(k) account; a temporary cash holding account and a 403(b) account; a temporary cash holding account and a 412(b) account; a temporary cash holding account and a trust; a temporary cash holding account and a social security privatization savings account; a stock account and an IRA savings account; a stock account and an IRC §529 education savings account; a stock account and a 401(k) account; a stock account and a 403(b) account; a stock account and a 412(b) account; a stock account and a trust; a stock account and a social security privatization savings account; a brokerage account and an IRA savings account; a brokerage account and an IRC §529 education savings account; a brokerage account and a 401(k) account; a brokerage account and a 403(b) account; a brokerage account and a 412(b) account; a brokerage account and a trust; a brokerage account and a social security privatization savings account; a mutual find account and an IRA savings account; a mutual fund account and an IRC §529 education savings account; a mutual fund account and a 401(k) account; a mutual fund account and a 403(b) account; a mutual fund account and a 412(b) account; a mutual fund account and a trust; a mutual fund account and a social security privatization savings account; a lifecycle investment account and an IRA savings account; a lifecycle investment account and an IRC §529 education savings account; a lifecycle investment account and a 401(k) account; a lifecycle investment account and a 403(b) account; a lifecycle investment account and a 412(b) account; a lifecycle investment account and a trust; a lifecycle investment account and a social security privatization savings account; a money market investment and an IRA savings account; a money market investment and an IRC §529 education savings account; a money market investment and a 401(k) account; a money market investment and a 403(b) account; a money market investment and a 412(b) account; a money market investment and a trust; or a money market investment and a social security privatization savings account.

The methods and systems disclosed herein include methods and systems for handling financial assets designated by an entity. The methods and systems may include taking a first asset facility designated by the entity, taking a second asset facility designated by the entity, and allocating a financial asset among the first asset facility and the second asset facility based on an analysis of a condition. In embodiments, the condition may include accelerated depreciation; an account balance; an accountant's opinion; earnings; a profit; a rate of return; active income; an activity ratio; an adjusted basis; an adjusted cost base; an adverse opinion; an aggressive investment strategy; an investment strategy; a conservative investment strategy; alpha; beta; an annual report; an appreciation; asset redeployment; an asset valuation; an audit; a balance sheet; a book value; a book-to-bill ratio; a book-to-market ratio; capital appreciation; capital employed; a capital gain; a capital structure; a capitalization; cash flow; cash flow after taxes; a cash flow statement; a chapter 11 filing; a chapter 7 filing; charge off; comparables; consolidated financial statements; current assets; current liabilities; current ratio; current yield; debt; debt-to-capital ratio; debt/equity ratio; deferred charge; deferred income tax; deferred revenue; depreciation; dilution; direct cost; disinvestment; divestiture; due diligence; earnings; economic exposure; economic spread; economic value added; effective tax rate; embedded value; expenses; explicit cost; fair value; a footnote; forward earnings; found money; free asset ratio; free cash flow; fundamental analysis; fundamentals; future income tax; a grandfather clause; gross income; gross processing margin; gross sales; growth rates; guidance; hidden values; impairment; implicit cost; income; an income statement; indicated dividend; an intangible asset; an interest expense; an interest rate risk; an internal growth rate; an internal rate of return; an intrinsic value; key performance indicators; liability; long-term assets; long-term debts; long-term debt/capitalization; long-term liabilities; market value; net asset value; net asset value per share; net debt; net income; net interest margin; net liquid assets; net loss; net present value; net worth; a nonrecurring charge; order flow; ordinary income; original cost; other current assets; other current liabilities; other long-term liabilities; a payout ratio; personal income; personal property; petty cash; pre-arranged trading; a preferred dividend coverage ratio; a price-to-earnings ratio; a price-to-book ratio; a price-to-cash-flow ratio; a price-to-sales ratio; a price-to-earning to growth ratio; a price-to-earnings to growth and dividend ratio; pro-form a earnings; a profit; a profit before tax; a qualitative analysis; a rate of return; a realized gain; a realized loss; retained earnings; return on assets; return on capital employed; return on equity; return on gross invested capital; return on investment; return on net assets; return on revenue; return on sales; revenue; risk adjusted return on capital; a sensitivity analysis; a short interest ratio; solvency; a solvency ratio; a Standard & Poor's 500 Index; a standard deviation; a sunk cost; sustainable growth rate; tangible net worth; a tax base; a taxable estate; taxes; a time-weighted rate of return; total debt to total assets; total enterprise value; trailing earnings per share; trailing price-to-earnings; an unrealized gain; an unrealized loss; a valuation; a variable cost; a variance; a withdrawal; a write-down; a write-off; a written-down value; a yield; a yield to maturity; or a zero-beta portfolio.

### BRIEF DESCRIPTION OF THE FIGURES

The foregoing and other object and advantages of the invention will be appreciated more fully from the following further description thereof, with reference to the accompanying drawings wherein:

FIG. 1 illustrates a computing facility used in some embodiments of a financial account management system.

FIG. 2 depicts an embodiment of the financial account management system.

FIG. 3 is a block diagram of the logical arrangement of elements in one implementation of the financial account management system.

FIG. 4, a block diagram, shows an expanded view of an asset transaction facility.

FIG. 5 is a block diagram of the logical arrangement of elements in another implementation of the financial account management system.

FIG. 6 is a block diagram of the logical arrangement of elements in still another implementation of the financial account management system.

FIG. 7 is a block diagram of a system allowing an asset owner to view parameters associated with his assets.

FIG. 8 is a block diagram of a system allowing the provision or modification of parameters associated with an asset owner.

FIG. 9 is a block diagram of a system allowing the provision or modification of parameters associated with an asset advisor.

FIG. 10 is a block diagram of a system allowing to provision or modification of parameters associated with one or more assets associated with the asset owner.

FIG. 11, a block diagram, depicts another embodiment of the financial account management system.

FIG. 12, a block diagram, depicts yet another embodiment of the financial account management facility.

FIG. 13, a block diagram, shows an expanded view of an exemplary embodiment of an advisor/owner server.

FIG. 14, a block diagram, shows an expanded view of an alternate embodiment of the advisor/owner server.

FIG. 15, a block diagram, shows an expanded view of an exemplary embodiment of an asset broker server.

FIG. 16, a block diagram, shows an expanded view of an alternate embodiment of the asset broker server.

FIG. 17, a block diagram, shows an expanded view of an exemplary embodiment of an event presentation server.

FIG. 18, a block diagram, shows an expanded view of an alternate embodiment of the event presentation server.

FIG. 19 is a logical flow diagram illustrating the operation of an implementation of the financial account management system.

FIG. 20 is a logical flow diagram illustrating the operation of another implementation of the financial account management system.

FIG. 21 is a logical flow diagram illustrating the operation of still another implementation of the financial account management system.

FIG. 22 is a block diagram showing an implementation of a Web browser used in an embodiment of the present invention.

FIG. 23 is a block diagram showing another implementation of the Web browser.

FIG. 24 is a block diagram showing still another implementation of the Web browser.

FIG. 25 is a block diagram showing an implementation of a telephone used in an embodiment of the present invention.

FIG. 26, a block diagram, illustrates a system for generating a spending habits report, which may be used in association with the financial account management system.

FIG. 27 is a logical flow diagram illustrating a leader service process, which may be used in association with the system for generating the spending habits report.

FIG. 28 is a block diagram showing a data file that may be used in association with the financial account information.

FIG. 29 is a listing of an embodiment of asset owner parameters, which may be associated with the asset owner.

FIG. 30 is a listing of an embodiment of asset advisor parameters, which may be associated with the asset advisor.

FIG. 31 is a listing of an embodiment of the set of asset parameters.

FIG. 32 is a depiction of a calendar of events.

FIG. 33 is a screenshot of a rendition provided by an asset review facility.

### DETAILED DESCRIPTION

The following description relates to methods and systems for automatically suggesting, recommending, and/or executing financial plans that are associated with an asset owner, a plurality of financial accounts associated with the owner, an asset advisor, and/or regulatory rules and restrictions. The financial plans may be directed at providing a stable retirement income to the owner, providing supplemental income during a phase of life of the owner, and/or providing to the owner a lump-sum cash payment associated with a life event of the owner. While some of the following embodiments may relate specifically to retirement accounts, it will be appreciated that the principles of the invention disclosed herein may be applied broadly to the management of a vast array of other special-purpose investment vehicles, financial instruments, or financial accounts all of which are referred to herein as asset facilities or the like. A small sampling of this array may include: medical savings accounts; college savings plans; checking accounts; savings accounts; brokerage accounts; mortgages; cash accounts; retirement accounts (such as an IRA, a Roth IRA, a SEP IRA, a 401(k), or a 403(b)); social security retirement accounts (SSRA); pensions; annuities; stock; restricted stock; stock options; certain trusts; whole life insurance; and the like. It will be clear to those familiar with the art that many of the aforementioned accounts, instruments, and vehicles may carry use restrictions or special tax treatments that can be managed within the systems described herein, and all such instruments or accounts are intended to fall within the scope of this disclosure. Furthermore, it will be appreciated that the principles of the invention disclosed herein may be applied broadly to the management of a vast array of liabilities or a combination of assets and liabilities.

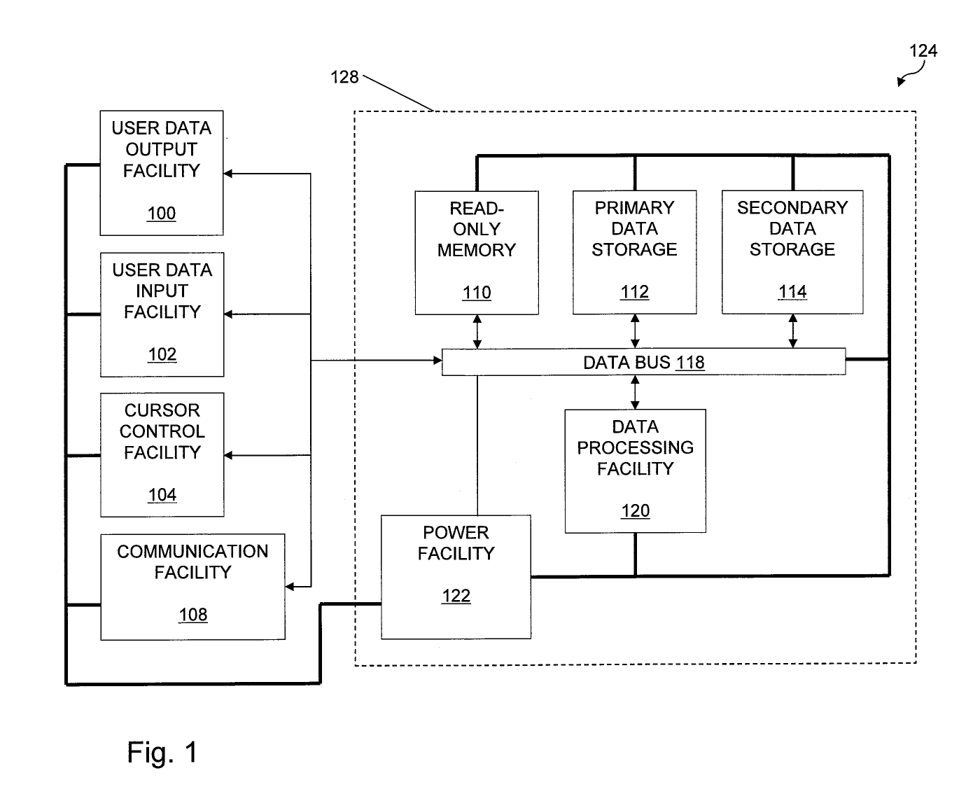

Referring to FIG. 1, there is depicted a computing facility 124 that may be used in embodiments of a financial account management system. The computing facility 124 may comprise a main processing unit 128 and a number of peripheral modules 100, 102, 104, 108. The main processing unit 128 itself may comprise a read-only memory 110, a primary data storage 112, a secondary data storage 114, a data bus 118, a data processing facility 120, and a power facility 122. The peripherals may comprise a user data output facility 100, a user data input facility 102, a cursor control facility 104, and a communication facility 108. As indicated by a heavy line, the power facility 122 may provide electrical power all of the other elements of the computing facility 124. In exemplary embodiments, this electrical power may be in the form of direct current.

The power facility 122 may comprise a transformer coupled to a power outlet, a battery, a solar cell, a fuel cell, and/or a generator (such as and without limitation comprising an internal combustion engine, an external combustion engine (e.g. a Sterling engine), a wind turbine, a wave-action or tidal-action facility, a hydroelectric facility, a geothermal facility, a human power source such as a wind-up generator or a pedal-powered generator, and so forth).

The data processing facility 120 may comprise a central processing unit such as and without limitation a server CPU (such as an Intel Xeon processor), a desktop CPU (such as an Intel Pentium processor), a mobile CPU (such as an Intel Centrino processor), an embedded CPU (such as an ARM7 processor), an ASIC, or any other microprocessor capable of sending and receiving data via the data bus 118 and processing said data.

The data bus 118 may be operatively coupled to the data processing facility 120, the read only memory 110, the primary data storage 112, the secondary data storage 114, and the power facility 122. Additionally, the data bus may be operatively coupled to the peripherals 100, 102, 104, 108. The operative coupling may provide data communications to and/or from the data bus 118. The data communications transmitted to the data bus 118 may be relayed to any or all of the modules that are operatively coupled to the data bus 118. In this way, any or all of the modules may transmit data to and/or receive data from any or all of the modules. In embodiments the data bus 118 may be embodied as a parallel data path that typically may consist of eight wires, sixteen wires, thirty-two wires, sixty-four wires, one hundred and twenty-eight wires, or any other number of wires. Additionally, the data bus 118 may comprise a number of wires for transmitting control information, such as information indicating the intended destination for the data communications on the bus 118, the precise timing of the data communications, and so forth.

The read-only memory 110 may consist of a non-volatile memory device capable of writing information to the data bus 118, but not (under normal operating circumstances) accepting for storage information from the data bus 118. The read-only memory 110 may comprise a ROM, a EPROM, a EEPROM, a CD-ROM drive, a DVDROM drive, one or more toggle switches, and so forth. In special operating circumstances, such as due to the application of a special electrical signal, it may be possible for the read-only memory 110 to accept information for storage from the data bus 118. For example and without limitation, the contents of a EEPROM may be erased and rewritten upon the application of a write enable signal.

The primary data storage 112 may consist of a read-write memory device (volatile or non-volatile). The primary data storage 112 may comprise SRAM, NV-RAM, any of a number of variants of DRAM, SGRAM, MRAM, FRAM, TTRAM, and so forth. The primary data storage 112 may be directed at providing data communications to and from the data bus 118 that are faster than the read-only memory 110 and the secondary storage 114. The secondary data storage 112 may consist of a read-write data storage device (usually non-volatile).

The secondary storage 114 may comprise a writeable or rewritable CD-ROM drive, a writeable or rewritable DVD-ROM drive, a hard disk drive, a flash memory device, a tape drive, and so forth. The operative coupling between the peripherals 100, 102, 104, 108 and the data bus 118 is shown to cross the boundary that delimits the outside of the main processing unit 128 from the inside. At this crossing, an adapter and/or port may be provided to allow data communications that are, at the physical level, suited to the peripherals 100, 102, 104, 108. Numerous examples of such adapters/ports exist in the art, such as a VGA port, a DVI port, a USB port, a Bluetooth wireless interface, an Ethernet Port, an WiFi or 802.11 interface, a FireWire or IEEE 1394 interface, an IrDA wireless interface, an S-Video interface, a PCMCIA port, and so forth.

The user data output facility 100 may comprise a graphical display device (such as a monitor), a visual display device (such as an ambient device), a aural rendering device (such as a speaker), a haptic feedback device (such as a vibrating device), a force-feedback device, or any other device directed at converting data communications from the main processing unit 128 into stimuli that can be perceived by a human.

The user data input facility 102 may comprise a keyboard, a microphone, a biometric scanner, a joystick, a paddle, a button, a switch, a slider, a knob, or any other device directed at converting stimuli provided by a human into data communications capable of being received at the main processing unit 128.

The cursor control facility may be a particular kind of user data input facility 102 specifically directed at accepting stimuli provided by a human to control the position or other action of a cursor displayed on a graphical display device. The other action may be the toggling of a selection action that, in the art, is typically associated with the depression or release of a mouse button. The cursor control facility 104 may comprise a mouse, a touch-point interface, a touch-pad interface, or any other such interface. The cursor control facility 104 may incorporate one or more buttons or other features that allow for the toggling of the selection action.

The communication facility 108 may comprise a device that is directed at providing data communications between one computing facility 124 and another computing facility 124. The communications facility 108 may comprise a telephone modem, cell phone modem, DSL modem, a cable modem, a satellite receiver/transmitter, a metropolitan area network access device, a WiMax interface device, a data service unit or DSU, and so forth.

It should be appreciated that in some embodiments the “peripherals” are, in fact, integrated into the main processing unit 128. Perhaps the most obvious example of this is the case of the computing facility 124 being a laptop computer, in which a keyboard, touch-pad interface and button, and built-in monitor are integrated into the main processing unit 128 and not attached through an adapter/port. It should further be appreciated that, in some embodiments, the communications facility 108 may be integrated into the main processing unit 128. It should still further be appreciated that, in some embodiments, the adapter/port may provide the functionality of the communication facility 108, such as and without limitation when the adapter/port is an Ethernet port or 802.11 interface.

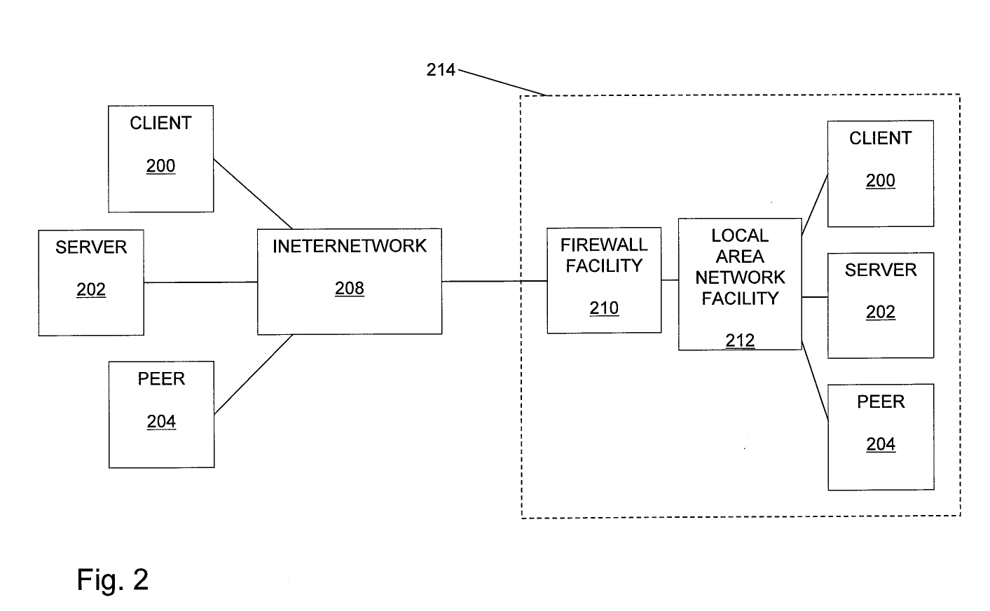

Referring now to FIG. 2, and embodiment of the financial account management system is shown, comprising one instance each of a client 200, a server 202, and a peer 204, all of which are operatively coupled to a network, which in an embodiment comprises an internetwork 208. The embodiment shown further comprises a local area network 214, itself comprising a security facility, which in embodiments comprises a firewall facility 210, a local area network facility 212, and one more instance each of the client 200, the server 202, and the peer 204, all of which are operatively coupled to the local area network facility 212. The firewall facility is operatively coupled to the internetwork 208 and the local area network facility 212. Each instance of the client 200, the server 202, and the peer 204 may comprise an instance of the computing facility 124.

The internetwork 208 may comprise a data communications network directed at providing data communications between clients 200, servers 202, peers 204, local area networks 214, and any other facility capable of transmitting and/or receiving data communications via an operative coupling to the internetwork 208. In one embodiment, the internetwork 208 may comprise the Internet, which is described in detail in the book, “The Internet Book Everything You Need to Know About Computer Networking and How the Internet Works,” by Douglas E. Corner, 3^{rd} Edition, published by Prentice Hall, 2000, included in its entirety herein by reference. The internetwork 208 may include any data communications network(s) such as a satellite network, a fiber optic network, a free-space optical network, a copper-wire network, a wired network, a wireless network, a radio frequency network, a microwave communications network, a telephone network, an asynchronous packet-data network, a synchronous packet-data network, a network providing quality-of-service guarantees, a network not providing quality-of-service guarantees, and so forth. The internetwork 208 may comprise a public communications network, a private communications network, a virtual private communications network, or a hybrid network in which some aspects are public while others are private, and so forth. This may include, for example local area networks, corporate area networks, campus area networks, metropolitan area networks, and any other private, local or wide area networks. In an exemplary embodiment, data may be transmitted over the internetwork 208 according to the TCP protocol, which is described in detail in “RFC 793: Transmission Control Protocol,” published by the Internet Engineering Task Force and included herein by reference.

The security facility or firewall facility 210 may comprise a special purpose instance of the computing facility 124, directed at facilitating, monitoring, and filtering data communications between computing facilities 124. In one embodiment, this special purpose instance of the computing facility 124 may feature the communication facility 108 integrated with main processing unit 128, no peripherals, and perhaps no secondary data storage 114. In another embodiment, this special purpose instance of the computing facility 124 may comprise the computing facility 124 in its usual form but running software directed at facilitating, monitoring, and filtering data communications. One example of such software is the FreeBSD operating system with its IPFILTER functionality in an appropriate configuration, numerous examples of which are readily available via a Google search on the terms “freebsd firewall.” The monitoring and filtering of data provided by the firewall facility 210 may comprise stateful packet inspection or non-stateful packet inspection, port blocking, port forwarding, network address translation, and so forth. The monitoring and filtering may include features directed at thwarting malicious utilization of the local area network 214 or any of the facilities within the local area network 214. Such features may include detecting and rejecting spoofs, denial-of-service attacks, or any other attempted malicious utilization of the local area network 112. The monitoring and filtering may additionally or alternatively include features directed at selectively denying data transmission from the local area network 214 to the internetwork 208. In an exemplary embodiment, the firewall facility 210 is capable of processing TCP data packets. In this embodiment, the monitoring and filtering may be directed at blocking TCP packets from the local area network 214 that are addressed to particular IP addresses on the internetwork 208 and/or that are addressed to particular ports associated with IP addresses on the internetwork 208. Other embodiments of the firewall facility 210 should be apparent from this disclosure or may be known in the art.

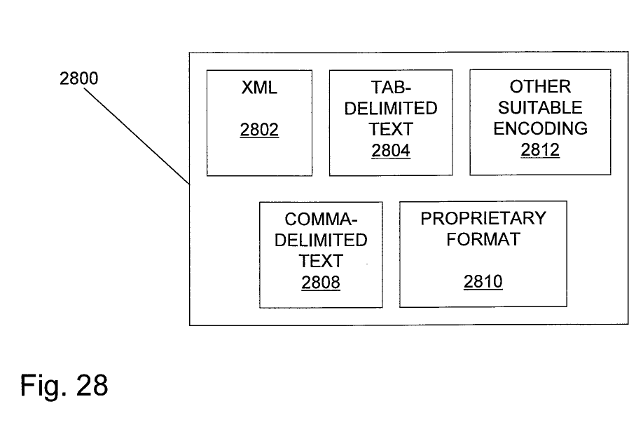

The local area network facility 212 may comprise a special purpose instance of the computing facility 124, directed at facilitating and directing communications between computing facilities 124 that are operatively coupled to it. In one embodiment, this special purpose instance of the computing facility 124 may feature a plurality or, perhaps, an abundance of instances of the communication facility 108, all of which may be integrated with the main processing unit 128; no peripherals; and perhaps with no secondary data storage 114. The local area network facility 212 may comprise what is known in the art as a router, a hub, a switch, and/or an access point. The facilitating and directing of communications may comprise features known in the art as load balancing, virtual local area networking, switching, routing, broadcasting (either in the packet-data sense or in the radiofrequency sense), multicasting, and such. Other embodiments of the local area network facility 212 should be apparent from this disclosure or may be known in the art. Referring now to FIG. 28, the financial account management system may embody information in a data file 2800. The data file 2800 may be suitable for processing and/or storing by the computing facility 124 and may comprise one or more encodings such as XML 2802, tab-delimited text 2804, comma-delimited text 2808, binary or textual data in a proprietary format 2810, or any other suitable encoding 2812.

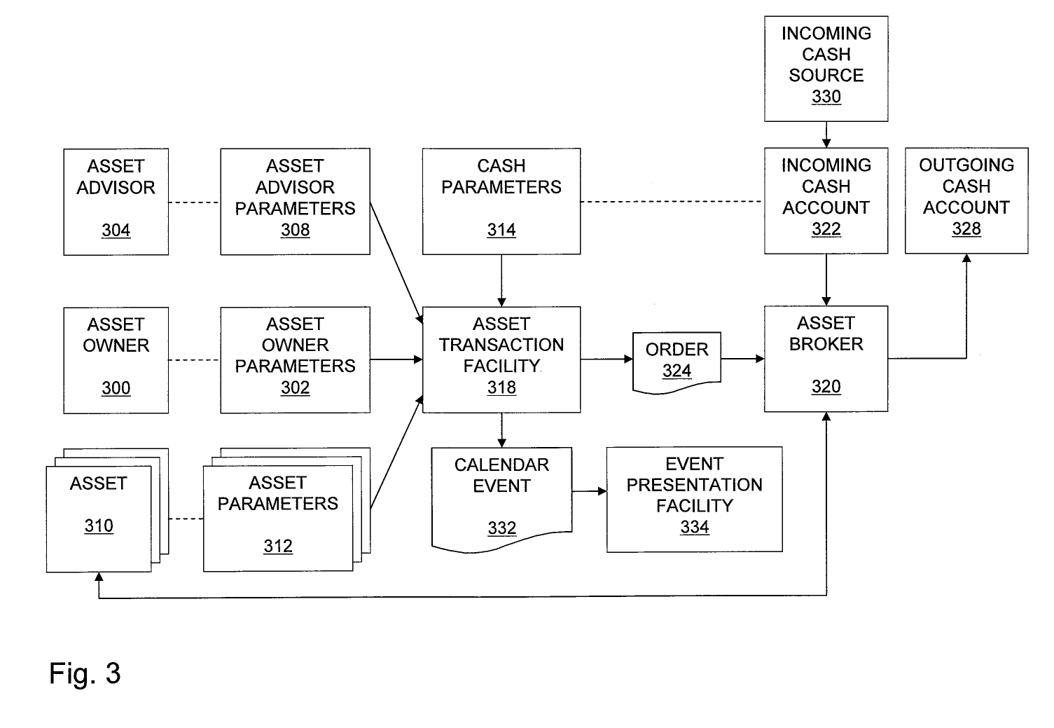

Referring now to FIG. 3, the logical arrangement of elements in one implementation of the financial account management system is shown. An asset advisor 304 may be associated with asset advisor parameters 308. An asset owner 300 may be associated with asset owner parameters 302. A set of assets 310 may be associated with a set of asset parameters 312. The asset advisor parameters 308, the asset owner parameters 302, and the asset parameters 312 may be received by an asset transaction facility 318.

Cash parameters 314 that may be associated with an incoming cash account 322 may be received by the asset transaction facility 318. The asset transaction facility 318 may produce an order 324 and/or a calendar event 332. The calendar event 332 may be received by an event presentation facility 334. The order 324 may be received by an asset broker 320. An incoming cash source 330 may provide funds to an incoming cash account 332. The asset broker 320 may, in complying with the received order 324, buy and/or sell one or more assets in the set of assets 310, providing funds to a seller of the assets 310 and/or receiving funds from a buyer of the assets 310, as may be necessary and/or resultant from the asset purchase and/or sale. To provide funds to the seller, the asset broker 320 may draw from the incoming cash account 322. After receiving funds from the buyer, the asset broker 320 may deposit the funds into the outgoing cash account 328 or, alternatively, into the set of assets 310 perhaps for future investment use.

The asset owner 300 may be an individual human being, a couple, or an association of people such as and without limitation a family that may utilize a Web service provided by the financial account management system. The asset owner 300 may own, may be desirous of owning, or may be the beneficiary of the set of assets 310. The asset owner 300 may be expected to experience a number of phases of life (or phases of relationship, or phases of association). These phases may include “in school,” “working,” “retired,” “semi-retired,” “homemaking,” and so forth. These phases may be punctuated by planned, unplanned, foreseeable, and unforeseeable major life events. Many examples of such events should be readily apparent and some are discussed hereinafter, particularly with reference to uses of the financial account management system. The asset owner 300 may also have a particular tolerance for investment risk, a general investment philosophy (such as, without limitation, investing primarily in environmentally-conscious companies), or other characteristic that may imply, suggest, or dictate which of a plurality of investment options would be viewed as attractive by the asset owner 300. The phases of life, the major life events (to the extent that they are knowable and can be assigned a likelihood), and the other characteristics may comprise the asset owner parameters 302. The asset owner parameters 302 may be embodied as an instance of the data file 2800. An embodiment of the asset owner parameters 302 is discussed hereinafter with reference to FIG. 28.

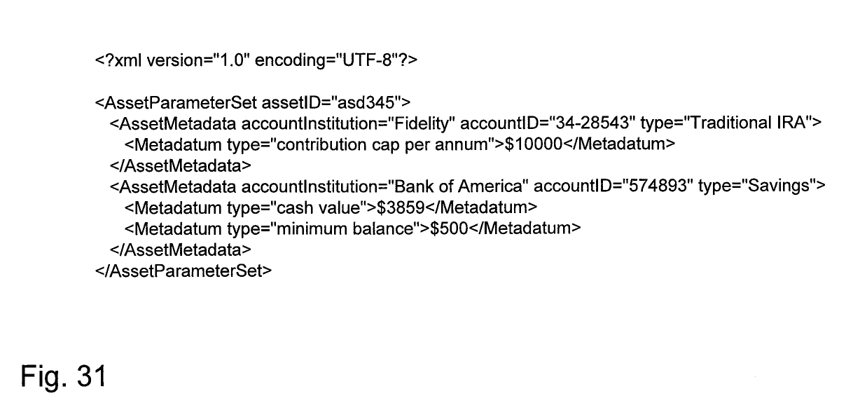

The asset advisor 304 may be an individual human being (such as, without limitation, a certified financial planner), an investment advisory firm (such as, without limitation, Merrill Lynch), a financial institution (such as, without limitation, a bank), an automatic computer system (such as, without limitation, those provided by Financial Engines, Inc.), or any other individual or organization offering investment advice to the asset owner 300. This investment advice may be provided in the form of a Web service. The asset advisor 304 may evaluate various statistics related to the assets 310 such as expenses, risk, tax-efficiency, expected returns over time, and so forth. This evaluation may culminate in the generation of asset ownership recommendations that may be codified as the asset advisor parameters 308. These parameters 308 may be embodied as an instance of the data file 2800. An embodiment of the asset advisor parameters 308 is discussed hereinafter with reference to FIG. 30. The set of assets 310 may comprise one or more assets or asset facilities owned by the asset owner 300 and under management by the financial account management system.

The assets 310 may comprise tax-advantaged accounts; tax-aware accounts; ATM related cash transfer and accumulation accounts; miscellaneous cash transfer accounts; temporary cash holding accounts; cash accumulation accounts; bank checking accounts; bank debit accounts; bank certificates of deposit and accounts containing them; bank savings accounts; bank passbook savings accounts; bank accounts containing assets insured by the FDIC; bank accounts linked together by so-called “home-link” banking software; mutual fund accounts; stock accounts; bond accounts; combined stock and bond accounts; brokerage accounts; brokerage investment accounts; brokerage wrap accounts; brokerage core accounts; whole life insurance; paid-up life insurance; term life insurance; variable annuity insurance; asset allocation investment accounts; “lifecycle” types of investment accounts; index fund investment accounts; money market investment accounts; education IRA savings accounts; IRC §529 education savings accounts; “post secondary school” savings accounts; 401(k) accounts; 403(b) accounts; 412(b) accounts; “retirement savings,” such as “target date retirement savings accounts”; trust, charitable and other investment accounts used in the estate planning process (as they may change from time to time due to changes in the federal and state laws), including but not limited to: “By-Pass Trust” Accounts (“Family Trust” Accounts); “Qualified Terminable Interest Trust” (“QTIP”) Accounts; Life Insurance Trust Accounts; Generation Skipping Trusts; Uniform Trusts for Minors Accounts and Uniform Gifts to Minors Accounts; Crummey Trust Accounts; Sprinkling (“Spray”) Trust Accounts; Special Needs Trust Accounts; Revocable Trust Accounts; Irrevocable Trust Accounts; Grantor Retained Annuity Trusts (“GRAT's”) Accounts and the Investment Accounts that are the Sources of the Trust Principal; Charitable Remainder Trust (“CRT's”) Accounts and the Investment Accounts that are the Sources of the Trust Principal; Charitable Remainder Annuity Trust (“CRAT's”) Accounts and the Investment Accounts that are the Sources of the Trust Principal; Charitable Remainder Unitrust (“CRUT's”) Accounts and the Investment Accounts that are the Sources of the Trust Principal; Pooled Income Fund Accounts and the Investment Accounts that are the Sources of the Trust Principal; Charitable Lead Trust Accounts and the Investment Accounts that are the Sources of the Trust Principal; Charitable Lead Unitrust Accounts and the Investment Accounts that are the Sources of the Trust Principal; Accounts related Premarital Agreements; Accounts related to Post-marital Agreements; Accounts related to the life-time investment management, estate planning and post-mortem investment management in connection with “Living Together” Agreements for gay couples; any so-called “Social Security Privatization Savings Accounts”; frequent flyer miles accounts; hotel rewards accounts; car rental rewards accounts; other rebate accumulation accounts; and the like. In embodiments, the set of assets 310 may be associated with, under the stewardship of, assigned to, or contained by one or more financial institutions. For example and without limitation, a bank account in the set of assets 310 may reside within Bank of America while a 401(k) account in the set of assets 310 may reside within Fidelity. It will be appreciated that the one or more financial institutions may or may not comprise the asset broker 320. It will further be appreciated that the one or more financial institutions may employ the financial account management system to provide the services of the financial account management system to the asset owner 300.

The assets 310 may further comprise the contents of any of the aforementioned accounts or combinations of such contents.

Various data or metadata may be associated with asset facilities or sets of assets 310. This data or metadata may be codified as the set of asset parameters 312. The set of asset parameters may comprise values corresponding to account number, cash value, net present value, maturity date, mandatory withdrawal rules, withdrawal penalties, contribution caps, contribution minimums, employer contribution matching, past performance, value line rating, Morningstar rating, fund manager, loads, fees, buy rating, sell rating, hold rating, acquisition date, tax basis, or any other data or metadata known in the art to be associated with asset facilities or assets 310. These parameters 312 may be embodied as an instance of the data file 2800. An embodiment of the set of asset parameters 312 is discussed hereinafter with reference to FIG. 31.

The incoming cash source 330 may be associated with the asset owner 300 may comprise the asset owner's 300 incoming cash flow. The source of this cash flow may comprise a salary, a professional services fee, a dividend, a disbursement, an inheritance, an insurance payout, a lottery winning, a reward, a bonus, and so forth. The source of this cash flow may additionally or alternatively comprise a credit card rebate, a charge card rebate, a bank card rebate, or any other cash rebate. The cash from the incoming cash source 330 may be deposited in the incoming cash account 322.

Cash parameters 314 may be associated with the incoming cash account 322. These parameters 314 may represent the current value of the incoming cash account 322, the expected value of the incoming cash account 322, the historical value of the incoming cash account 322, a restriction on withdrawals from the incoming cash account 322, an account number associated with the incoming cash account 322, or any other measurement of or metadata associated with the incoming cash account 322. These parameters may be embodied as an instance of the data file 2800.

The asset broker 320 may be a brokerage, an insurance broker, a real estate broker, a stock broker, a broker/dealer, a banker, a bond broker, an commodities broker, an options broker, a prime brokerage, a retail broker, a low cost broker, or any other party that mediates between the asset owner 300 and a third-party during a transaction involving the assets 310, the asset owner 300, and the third-party (who may be the buyer or seller of the assets 310 involved). The asset broker 320 may buy and/or sell assets 310, according to the instructions in the order 324. This buying and/or selling of the assets 310 may be provided as a Web service. The order, which may be embodied as an instance of the data file 2800, may comprise a buy order, a sell order, a limit order, a stop order, a stop-loss order, an order cancellation, an option-exercise order, or any other order.

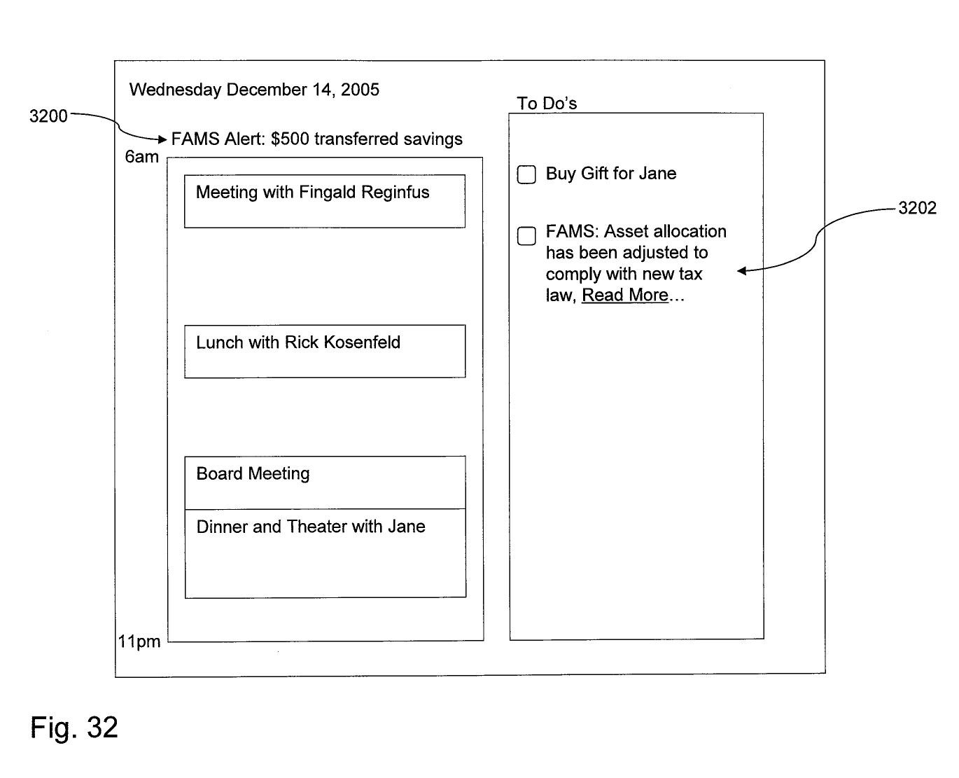

The event presentation facility 334 may be an application program or a Web service capable of providing the asset owner 300 with a chronological view of an event, such as a calendar event 332. One such view may be the inclusion of the event 332 in a calendar, such as is discussed hereinafter with reference to FIG. 32. The calendar event 332, which may be embodied as an instance of the data file 2800, may comprise a textual description associated with a date. Typically, the textual description may refer to an equity trade; a change in tax law; an account roll over; a triggered message; an information subscription; a market event; a life event, such as and without limitation a transition into or out of a phase in the asset owner's 300 life (such as and without limitation, retirement); a change in a governmental regulation; a change in a term and/or condition pertaining to the asset owner's 300 access to the set of assets 310; a social security retirement account; and so forth.

The outgoing cash account 328 may be owned by the asset owner 300 and may be a bank checking account, a bank savings account, a money market account, a debit card account, or any other account that the asset owner 300 may typically use as a spending or withdrawal account. It should be appreciated that, in embodiments, there may not be a clear distinction between the outgoing cash account 328 and the set of assets 310.

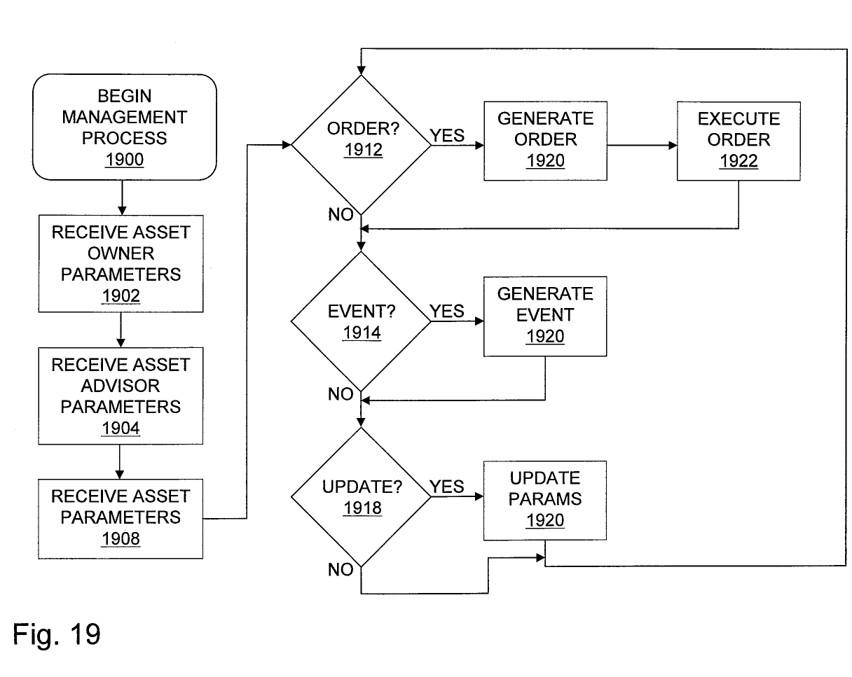

The logical flow of operations performed by the financial account management system, when arranged as depicted, is discussed hereinafter with reference to FIG. 19.

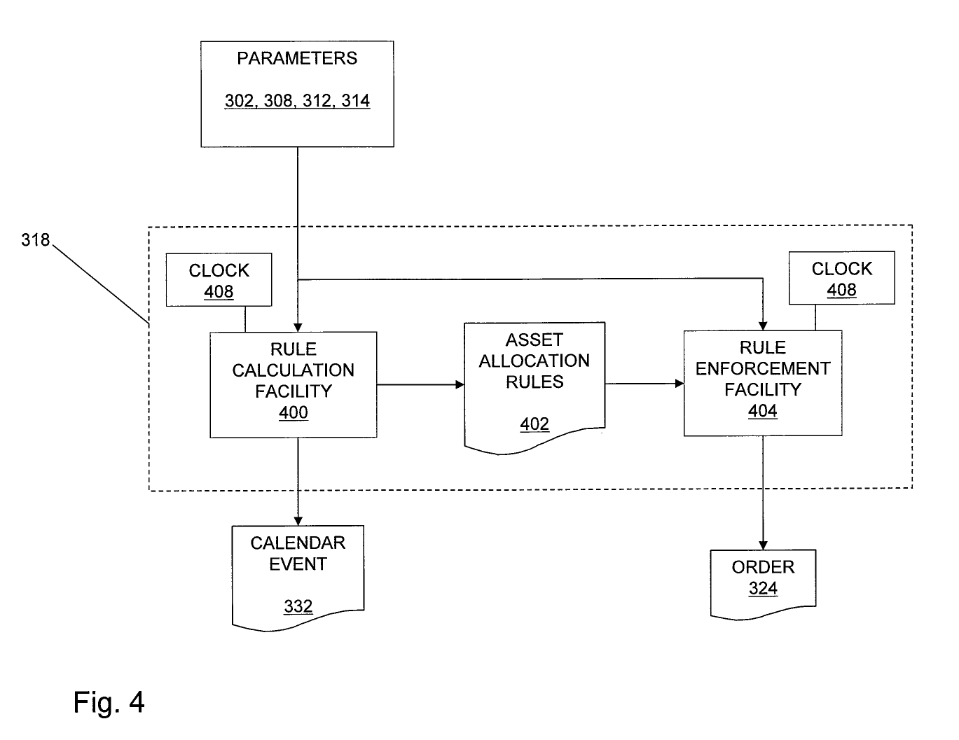

Referring now to FIG. 4, the asset transaction facility 318 may receive the parameters 302, 308, 312, 314 (referred to hereinafter as “the input parameters”) at the rule calculation facility 400 and at the rule enforcement facility 404. Both the rule calculation facility 400 and the rule enforcement facility 404 may receive input from a clock 408. The rule calculation facility may generate asset allocation rules 402 that may be received by the rule enforcement facility 404. The rule calculation facility 400 may produce the calendar event 332. The rule enforcement facility 404 may produce the order 324. In embodiments, the input parameters may relate to an accounting parameter such as and without limitation accelerated depreciation; account balance; accountant's opinion; earnings; a profit; a rate of return; active income; an activity ratio; an adjusted basis; an adjusted cost base; an adverse opinion; an aggressive investment strategy; an investment strategy; a conservative investment strategy; alpha; beta; an annual report; an appreciation; asset redeployment; an asset valuation; an audit; a balance sheet; a book value; a book-to-bill ratio; a book-to-market ratio; capital appreciation; capital employed; a capital gain; a capital structure; a capitalization; cash flow; cash flow after taxes; a cash flow statement; a chapter 11 filing; a chapter 7 filing; charge off; comparables; consolidated financial statements; current assets; current liabilities; current ratio; current yield; debt; debt-to-capital ratio; debt/equity ratio; deferred charge; deferred income tax; deferred revenue; depreciation; dilution; direct cost; disinvestment; divestiture; due diligence; earnings; economic exposure; economic spread; economic value added; effective tax rate; embedded value; expenses; explicit cost; fair value; a footnote; forward earnings; found money; free asset ratio; free cash flow; fundamental analysis; fundamentals; future income tax; a grandfather clause; gross income; gross processing margin; gross sales; growth rates; guidance; hidden values; impairment; implicit cost; income; an income statement; indicated dividend; an intangible asset; an interest expense; an interest rate risk; an internal growth rate; an internal rate of return; an intrinsic value; key performance indicators; liability; long-term assets; long-term debts; long-term debt/capitalization; long-term liabilities; market value; net asset value; net asset value per share; net debt; net income; net interest margin; net liquid assets; net loss; net present value; net worth; a nonrecurring charge; order flow; ordinary income; original cost; other current assets; other current liabilities; other long-term liabilities; a payout ratio; personal income; personal property; petty cash; pre-arranged trading; a preferred dividend coverage ratio; a price-to-earnings ratio; a price-to-book ratio; a price-to-cash-flow ratio; a price-to-sales ratio; a price-to-earning to growth ratio; a price-to-earnings to growth and dividend ratio; pro-form a earnings; a profit; a profit before tax; a qualitative analysis; a rate of return; a realized gain; a realized loss; retained earnings; return on assets; return on capital employed; return on equity; return on gross invested capital; return on investment; return on net assets; return on revenue; return on sales; revenue; risk adjusted return on capital; a sensitivity analysis; a short interest ratio; solvency; a solvency ratio; a Standard & Poor's 500 index; a standard deviation; a sunk cost; a sustainable growth rate, a tangible net worth; a tax base; a taxable estate; taxes; a time-weighted rate of return; total debt to total assets; total enterprise value; trailing earnings per share; trailing priceto-earnings; unrealized gain; unrealized loss; valuation; variable cost; a variance; a withdrawal; a write-down; a write-off; a written-down value; a yield; a yield to maturity; a zero-beta portfolio; and the like.

The rule calculation facility 400 may operate on the input parameters and a current time, provided by the clock 408, to generate the asset allocation rules 402, which when followed by the rule enforcement facility 404 will result in one or more orders 324 that are consistent with the input parameters. The rule calculation facility 400 may consider a number of investment strategies, such as and without limitation a tax minimization strategy, a growth strategy (optionally having different levels of aggressiveness), an asset preservation strategy, an asset allocation strategy, a rebalancing strategy, a hedge strategy, a dividend reinvestment strategy, a strategy to fund a particular need, a fee minimization strategy, a load minimization strategy, or one of many market strategies (e.g., international growth, strategies relating to commodities, real estate strategies, or the like). The particular strategies to be considered may be specified by the input parameters. In one example, the rule calculation facility 400 may determine the asset allocation rules 402 that, when followed, would result in a rebalancing of the assets 310 according to a particular asset allocation strategy. In another example, rule calculation facility 400 may determine the asset allocation rules 402 that, when followed, would result in orders 324 that are consistent with a tax minimization strategy. The rule calculation facility may be implemented as a heuristic, many of which are described hereinafter and still more of which will be apparent from the present disclosure. The asset allocation rules 402 may be embodied as an instance of the data file 2800.

The rule enforcement facility 404 may generate the order 324 by operating on the asset allocation rules 402, the input parameters, and the current time (collectively referred to in this paragraph as “the inputs”). This operation may consist of mapping the inputs to the order 324. The rule enforcement facility 404 may be embodied as an expert system or rules engine that applies the asset allocation rules 402 to the information contained in the input parameters and the current time to produce a course of action that may be embodied as one or more of the orders 324. Alternatively, the rule enforcement facility 404 may be implemented as a heuristic, many of which are described hereinafter and still more of which will be apparent from the present disclosure.

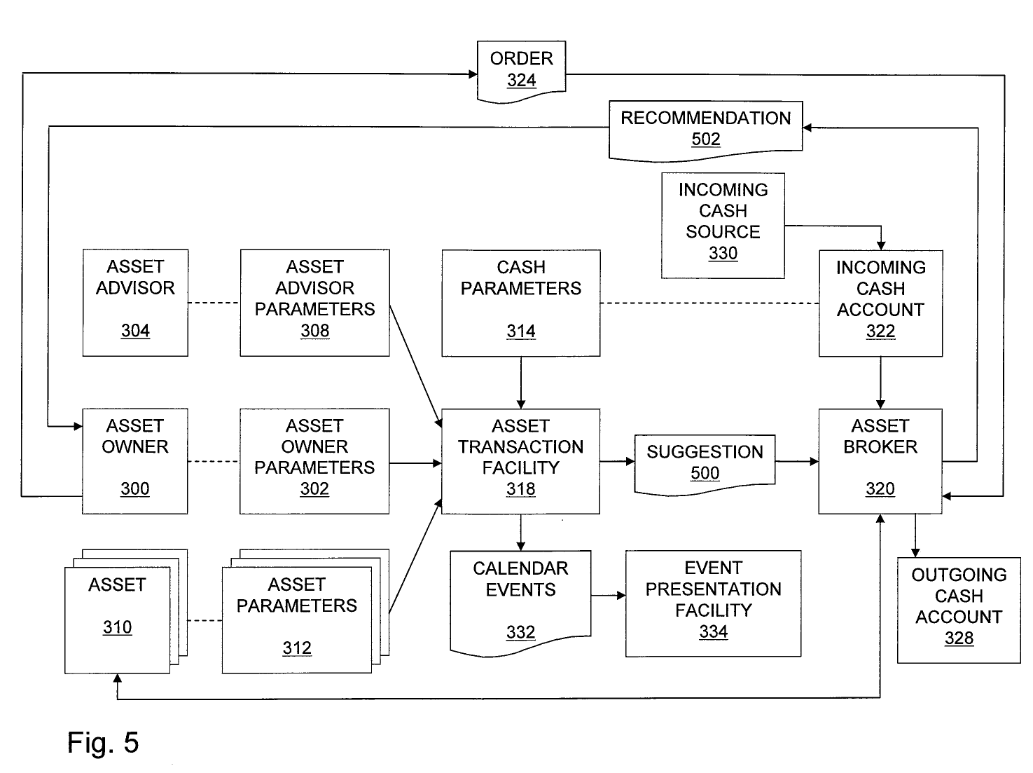

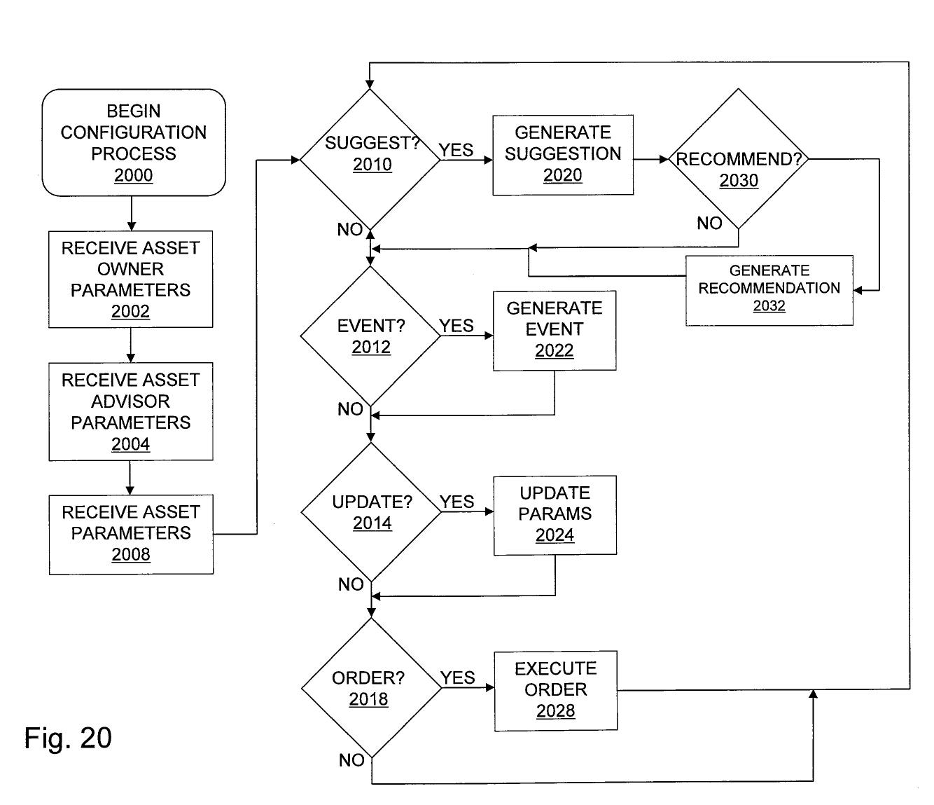

Referring now to FIG. 5, in the logical arrangement of elements in another implementation of the financial account management system, the asset transaction facility 318 may provide a suggestion 500, rather than the order 324, to the asset broker 320. The asset broker 320, may issue a recommendation 502 that may be received by the asset owner 300. The asset owner may act on the recommendation 502 by transmitting the order 324 to the asset broker 320. The asset broker may act on the order 324 as discussed hereinabove with reference FIG. 3. The suggestion 500, which may be embodied as an instance of the data file 2800, may comprise a textual description or encoding of a suggested order. The recommendation 502, which may be embodied as an instance of the data file 2800, may comprise a textual description of a recommended order. The logical flow of operations performed by the financial account management system, when arranged as depicted, is discussed hereinafter with reference to FIG. 20.

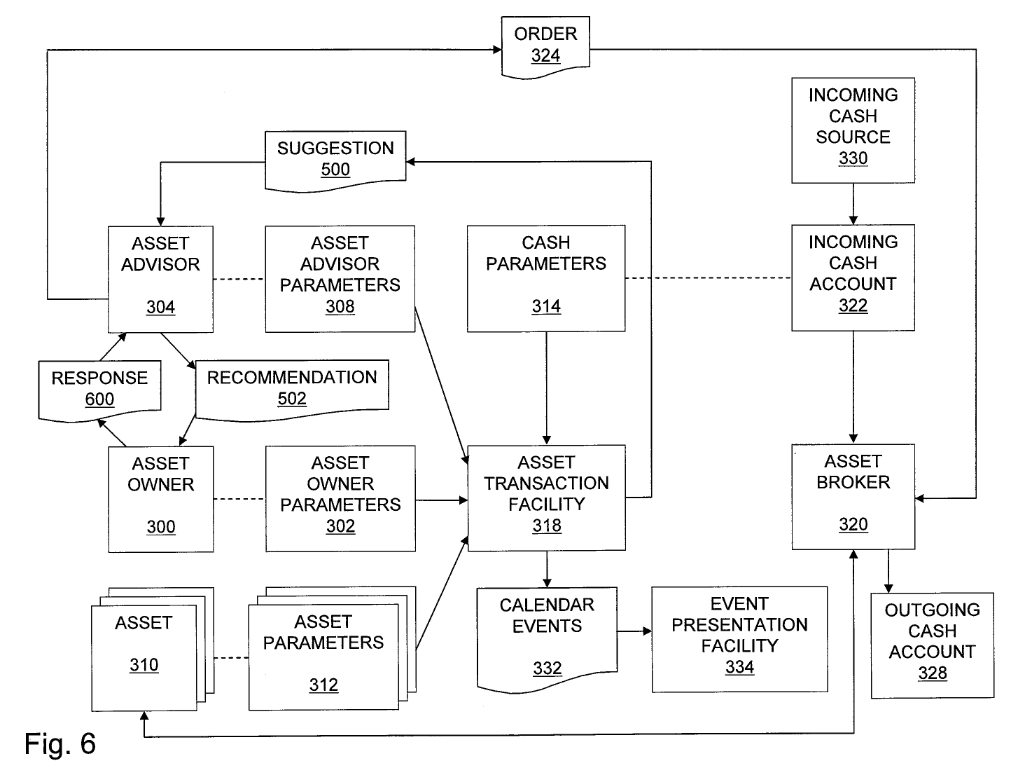

Referring now to FIG. 6, in yet another implementation of the financial account management system, the asset transaction facility 318 may provide the suggestion 500 to the asset advisor 304. The asset advisor 304, in turn, may issue the recommendation 502 to the asset owner 300. The asset owner 300, then, may issue a response to the asset advisor 304. Taking into account the response 600, the asset advisor 304 may issue the order 324 to the asset broker 320. The response 600, which may be embodied as an instance of the data file 2800, may comprise an indication of the asset owner's 300 desire to execute the recommended order described in the recommendation 502. The response 600 is discussed in greater detail hereinafter with reference to FIG. 38.

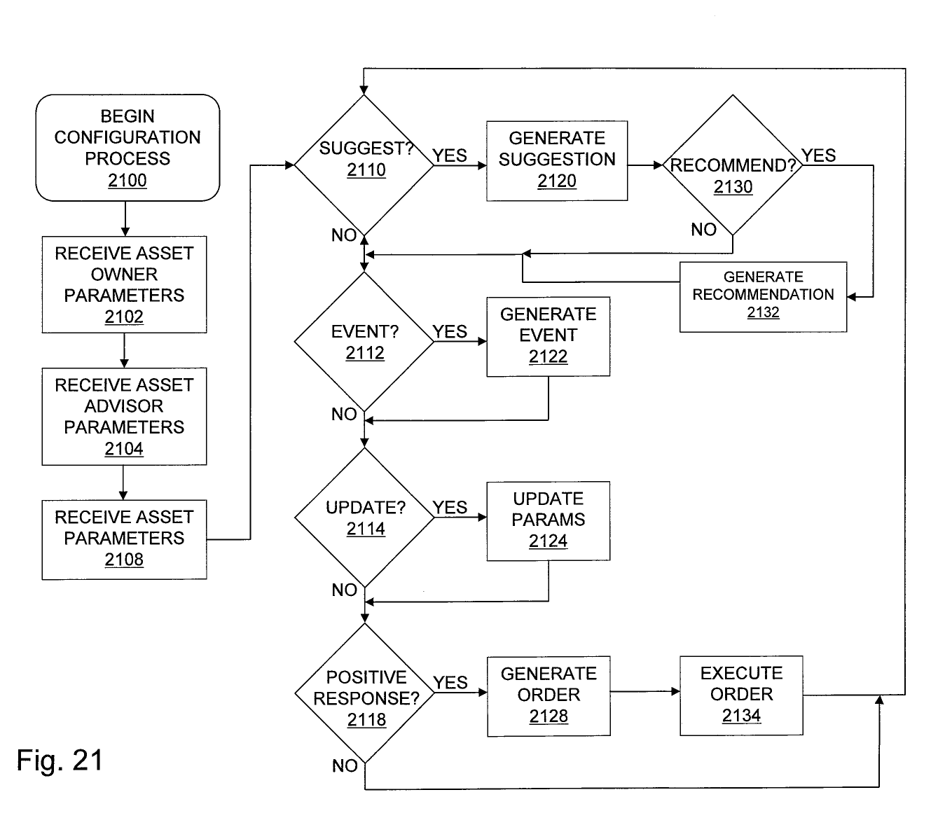

The logical flow of operations performed by the financial account management system, when arranged as depicted, is discussed hereinafter with reference to FIG. 21.

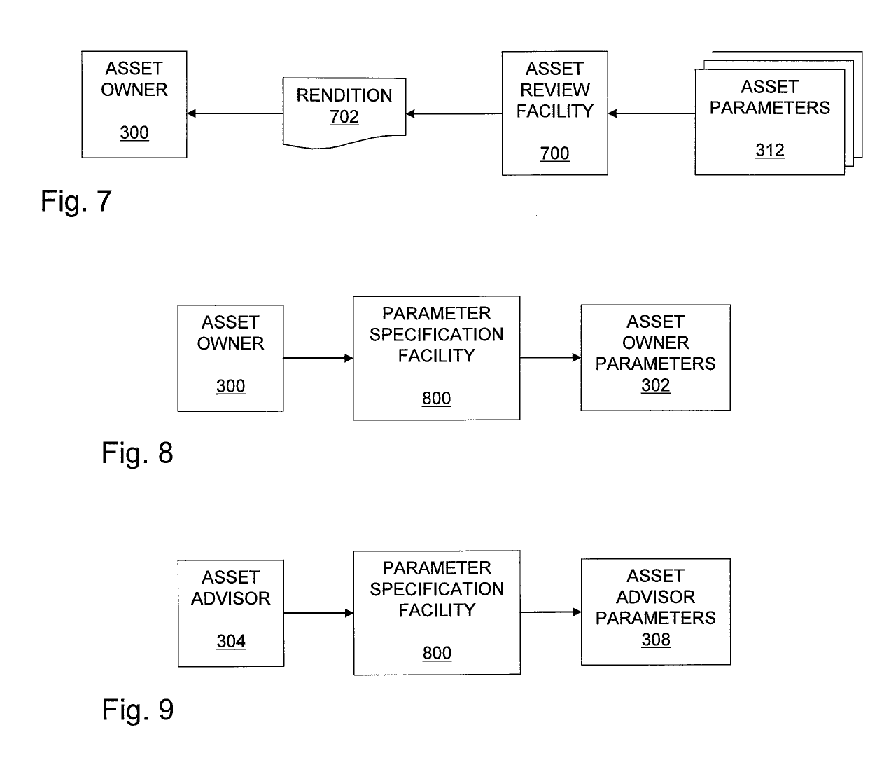

Referring now to FIG. 7, the asset parameters 312 may be received by an asset review facility 700. The asset review facility 700 may present a rendition 702 of the asset parameters 312 to the asset owner 300. The asset review facility 700 may comprise a software application with a graphical user interface running on a computer that is associated with the asset owner 300. In particular, the asset review facility 700 may comprise a Web service associated with a Web server that is operatively coupled, such as via data communications, to a Web browser that is the software application with a graphical user interface running on the computer that is associated with the asset owner 300. The rendition 702 provided by the asset review facility 700 may enable the asset owner 300 to review any number of the asset parameters 312, which may comprise financial measures or regulatory restrictions associated with the set of assets 310. These measures and restrictions may include current value, net present value, tax basis, beta, p/e ratio, book value, market cap, margin/equity ratio, asset mix, maturity dates, dividend yields, mandatory withdrawal requirements, maximum contribution limits, fees, loads, withdrawal penalties, exceptions to withdrawal penalties, and so forth. The rendition 702 provided by the asset review facility is discussed hereinafter with reference to FIG. 42.

Referring now to FIG. 8, the asset owner 300 may add, modify, or delete any of the asset owner parameters 302 by utilizing a parameter specification facility 800. The parameter specification facility 800 may comprise a software application with a graphical user interface running on a computer that is associated with the asset owner 300. The computer that is associated with the asset owner 300 may be the client 200. In particular, the parameters specification facility 800 may comprise a Web service associated with a Web server that is operatively coupled, such as via data communications, to a Web browser that is the software application with a graphical user interface running on the computer that is associated with the asset owner 300. The Web server may be the server 202. The asset owner parameters 302 may without limitation comprise a date of birth, a social security number, an estimated income, an estimated expense, actual income, an actual expense, a state of residence, a mailing address, a billing address, a username, a password, a password hint, a marital status, a name of spouse, a social security number of spouse, a number of dependents, a name of a dependent, a social security number of a dependent, a risk tolerance (perhaps on a scale of low to high), an estimated retirement date, a desired retirement date, an estimated monthly retirement allowance, a desired monthly retirement allowance, an estimated final estate value, a desired final estate value, information pertaining to a scheduled medical procedure, information pertaining to an unscheduled medical procedure, information pertaining to a childbirth, information pertaining to a private education, information pertaining to a primary education, information pertaining to a secondary education, a value associated with a vehicle owned by the asset owner 300 (such as a VIN, odometer reading, and so forth), an indication of a smoking habit, an indication of a drug habit, an indication of a physical fitness habit, an indication of an affiliation with a professional financial advisory association, a and so on.

Referring now to FIG. 9, the asset advisor 304 may add, modify, or delete any of the asset advisor parameters 308 by utilizing the parameter specification facility 800. In this case, the parameter specification facility 800 may comprise a software application with a graphical user interface running on a computer that is associated with the asset advisor 304. The computer that is associated with the asset advisor 304 may be the client 200. In particular, in this case, the parameter specification facility 800 may comprise a Web service associated with a Web server that is operatively coupled, such as via data communications, to a Web browser that is the software application with a graphical user interface running on the computer that associated with the asset advisor 304. The Web server may be the server 202. The asset advisor parameters 308 may without limitation comprise any information associated with portfolio management, retirement planning, estate planning, education planning, insurance, taxes, and/or business finances.

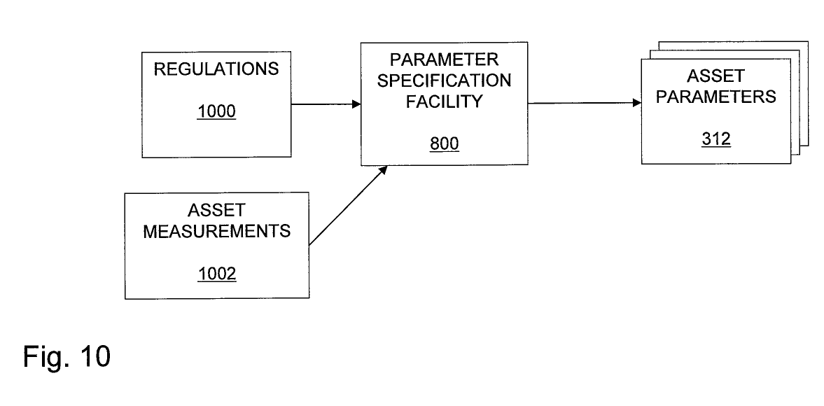

Referring now to FIG. 10, the parameter specification facility 700 may receive regulations 1000 and asset measurements 1002. The parameter specification facility 800 may utilize these regulations 1000 and asset measurements 1002 to add, modify, or delete any of the asset parameters 312. In this case, the parameter specification facility 800 may comprise a Web service associated with a Web server. The Web server may be the server 202. The regulations 1000 and the asset measurements 1002 may be received by the parameter specification facility 800 from an automatic computer facility, which may comprise the client 200, the server 202, or the peer 204. Alternatively, the regulations 1000 and the asset measurements 1002 may be received by the parameter specification facility 800 via one or more of the peripherals that may be associated with the server 202 that may be the parameter specification facility 800. The regulations 1000 may encode investment rules, investment limitations, exceptions to the investment rules or the investment limitations, any other information of a regulatory nature that is associated with the set of assets 310, or any of the restrictions that may be associated with the asset parameters 312, as discussed hereinabove with reference to FIG. 7. This information may be received in the form of a Web page, an XML data item or data feed, a manual data entry, and so forth. The regulations 1000 may be embodied as an instance of the data file 2800. The asset measurements 1002 may encode any of the measurements that may be associated with the asset parameters 312 and may be embodies as an instance of the data file 2800.

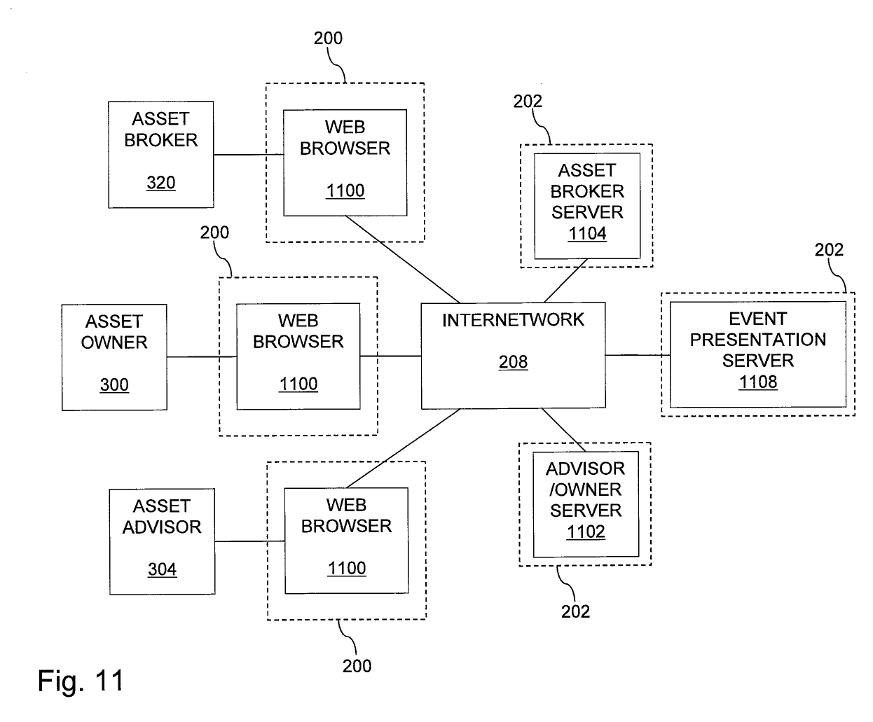

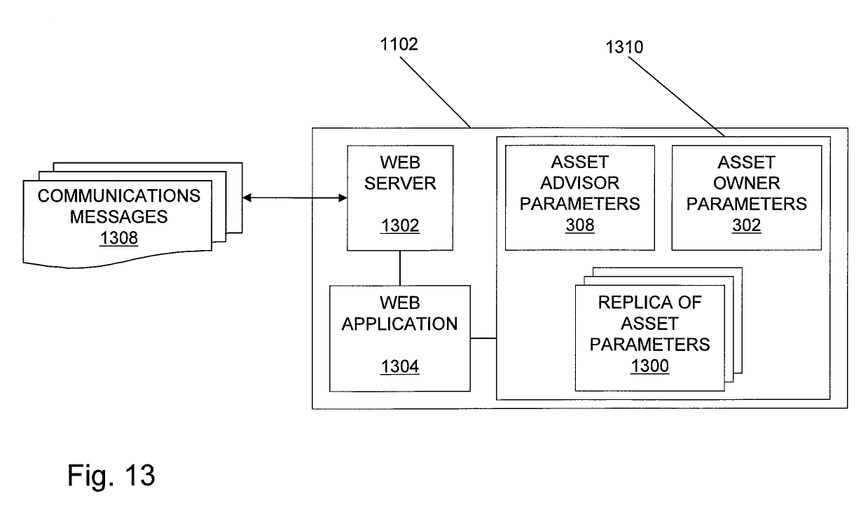

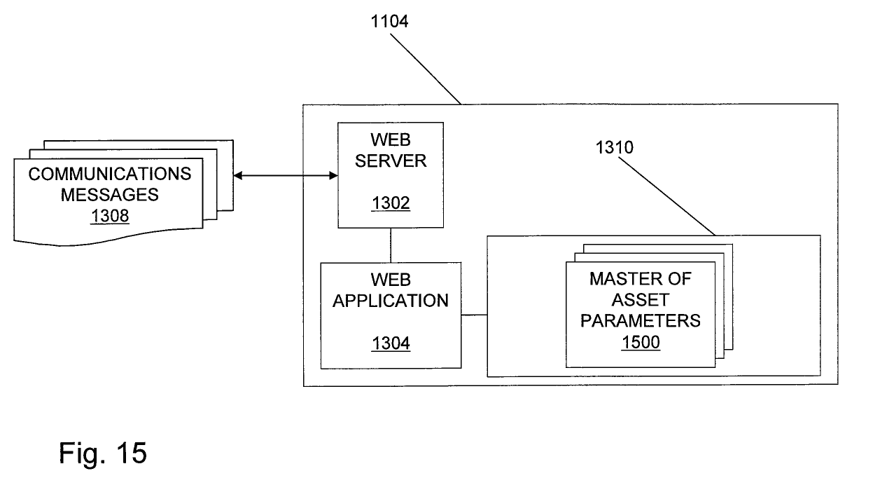

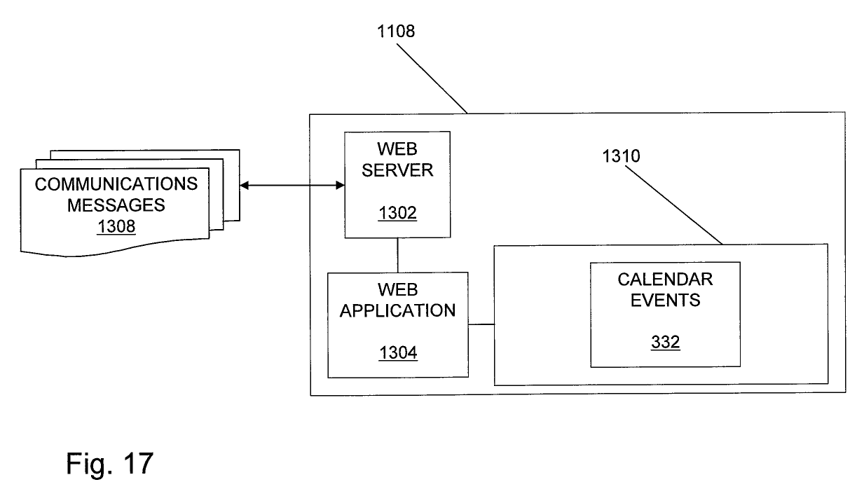

Referring now to FIG. 11, an embodiment of the financial account management system may comprise a number of instances of the client 200, in which a Web browser 1100 may be operating. The asset owner 300, the asset advisor 304, and the asset broker 320 may each be associated with one of the instances of the client 200 and may each utilize the Web browser 1100 within their respective associated instances of the client 200. The instances of the Web browser 1100 (which may without limitation comprise Mozilla Firefox, Internet Explorer, Apple Safari, and the like) may be operatively coupled, such as via data communications, to an asset broker server 1004, an advisor/owner server 1102, and/or event presentation server 1108. The primary purpose of the Web browser 1100 may be to render data communications received by the servers 1002, 1004 and to, based upon input from a human user, transmit data communications to the servers 1002, 1004. The asset broker server 1004, the advisor/owner server 1102, and the event presentation server 1108 each may be provided by an instance of the server 202. The advisor/owner server 1002 as it pertains to this embodiment of the financial account management system is discussed hereinafter with references to FIG. 13. The asset broker server 1104 as it pertains to this embodiment of the financial account management system is discussed hereinafter with references to FIG. 15. The event presentation server 1108 as it pertains to this embodiment of the financial account management system is discussed hereinafter with references to FIG. 17

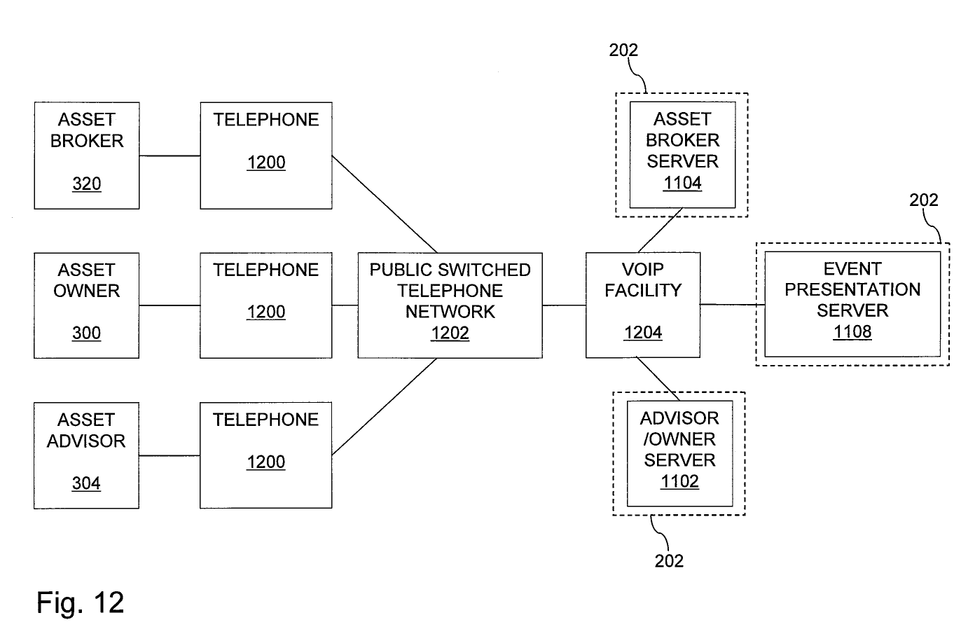

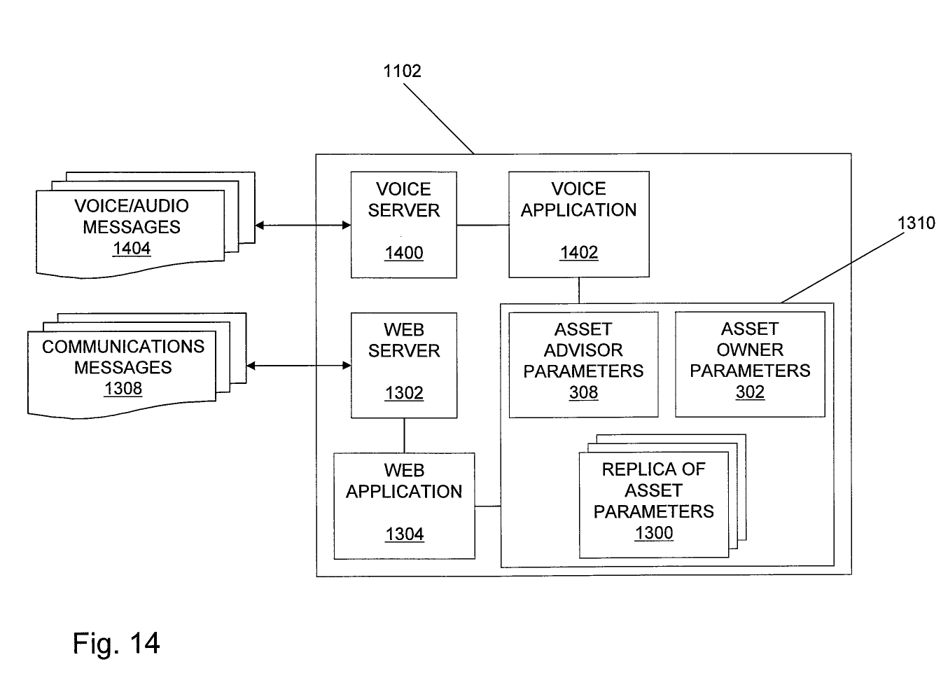

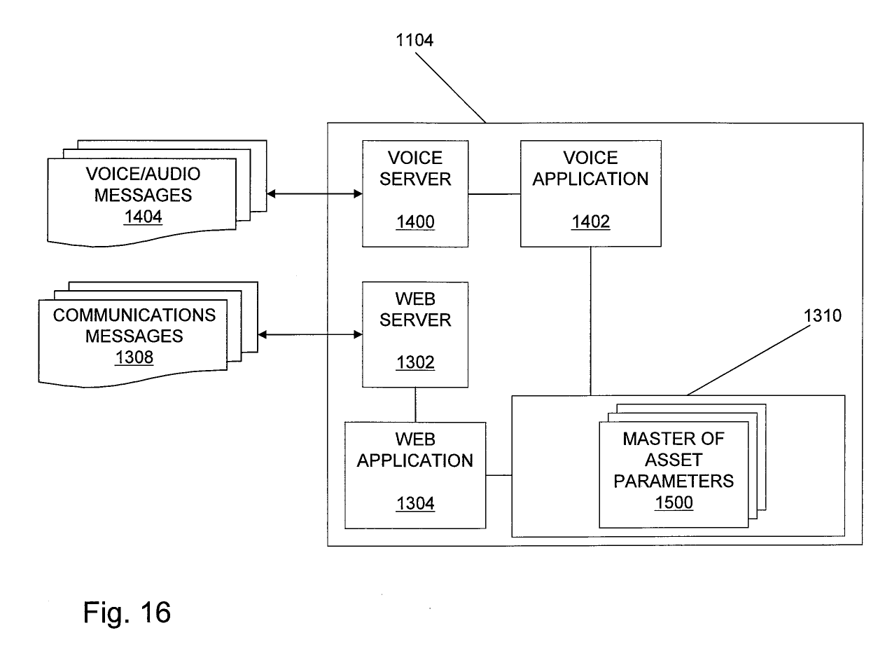

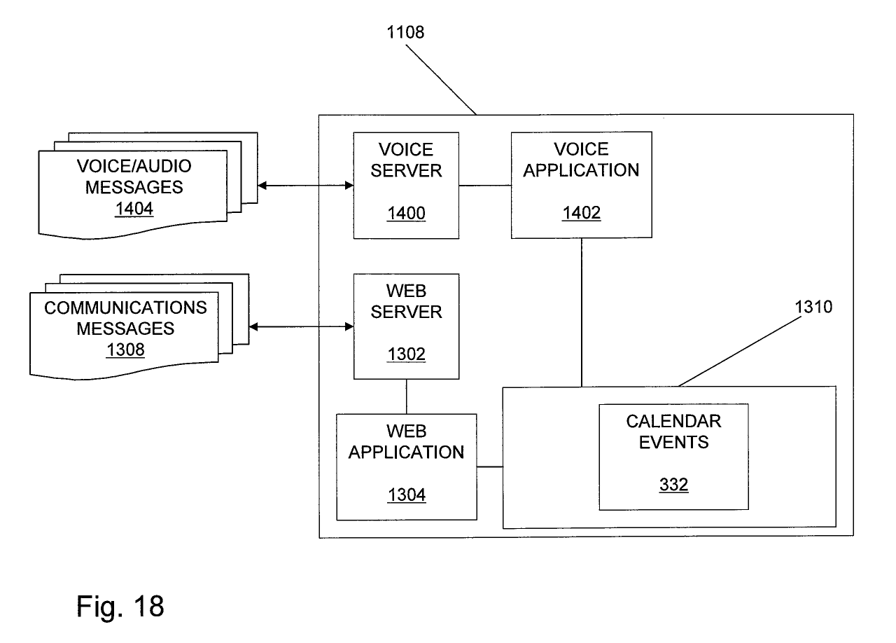

Referring now to FIG. 12, another embodiment of the financial account management system may comprise a number of instances of the server 202, in which may be operating the asset broker server 1104, the event presentation server 1108, and the advisor/owner server 1102. The advisor/owner server 1102, the asset broker server 1104, and the event presentation server 1108 as they pertain to this embodiment of the financial account management system are described in detail hereinafter with references to FIG. 14, FIG. 16, and FIG. 18 respectively. In this embodiment the instances of the server 202 may be operatively coupled, such as via data communications, to a voice-over-IP (or VoIP) facility 1204. Whereas the asset broker server 1104, the asset review facility 700, the event presentation facility 334, the parameter specification facility 800, and the advisor/owner server 1102 may utilize HTTP as a form of data communications when utilized as discussed hereinabove with reference to FIG. 11, they may utilize VoiceXML as a form of data communications when utilized as depicted here. The VoIP facility 1204 may comprise a VoIP gateway, a VoiceXML interpreter, and an application server (such as and without limitation Tomcat, WebLogic, .NET server, Web Sphere, and so forth). The application server may receive data communications and pass them to the VoiceXML interpreter. The VoiceXML interpreter may generate data corresponding to a spoken audio signal, which may be converted into an analog audio signal by a codec that is integral to the VoIP facility 1204. Two-way audio communications (which, in embodiments, may comprise a digital signal or an analog signal) may be established between the VoIP facility 1202 and a public switched telephone network 1202. The public switched telephone network (PSTN) 1202 is well known in the art and is described in detail in the book, “Introduction to Public Switched Telephone Networks; POTS, ISDN, DLC, DSL, and PON Technologies, Systems and Services,” by Lawrence Harte and Robert Flood, 2^{nd} edition, published by Althos, 2005. The asset broker 320, the asset owner 300, and the asset advisor 304 may each utilize an instance of a telephone 1200, which may be operatively coupled to the PSTN 1202. The telephone may be a VoIP telephone, a cellular telephone, a traditional analog telephone, a satellite telephone, or any other telephone. In this embodiment, from the perspective of the asset broker 320, the asset owner 300, and the asset advisor 304, the Web browser 1100 and associated client 200 of the embodiment discussed hereinabove with reference to FIG. 11 is replaced with voice prompts and speech input received from and delivered to the telephone 1200. In other words, instead of viewing information presented in a graphical user interface, the users of the instances of the telephone 1200 may listen to information spoken through the telephone 1200. Likewise, instead of providing information via a graphical user interface such as by typing on a user data input facility 102 or using a cursor control facility 104, the users of the instances of the telephone 1200 may speak information into the telephone 1200, optionally in response to voice prompts.

Referring now to FIG. 13, an exemplary embodiment of the advisor/owner server 1102 may comprise a database management system 1310 containing a replica 1300 of the set of asset parameters 312, the asset owner parameters 302, and the asset advisor parameters 308; a Web application 1304; a Web server 1302; and a number of communications messages 1308. The database management system 1310 may be an instance of Oracle, MySQL, PostgreSQL, or any other database management system. The database management system 1310 may be operatively coupled to the Web application 1304, such as via ODBC, JDBC, or any other application-to-database-management system connection mechanism. The Web application 1304 may be associated with a Web server 1302, such as by running in an application server affiliated with the Web server 1302. The Web server 1302 (which may without limitation comprise Apache, Microsoft IIS, Netscape Enterprise, and the like) may receive and transmit the communications messages 1308, each of which may be embodied as an instance of the data file 2800. The communications messages 1308 may embody the data communications between the servers 1102, 1104 and the instances of the Web browser 1100. In embodiments, the communications messages 1308 may be in the HTML format and may be provided to and received from the Web browser 1100. The advisor/owner server 1102 may comprise the asset review facility 700 and/or the parameter specification facility 800.

The Web application 1304 may provide functions associated with or identified as the Web service provided by the asset advisor 304 and/or utilized by the asset owner 300. For example, the Web application 1304 may extract information from the database management system 1310 in response to communications messages 1308 received from the asset owner 300 or the asset advisor 304 via the Web server 1302. This information may be processed by the Web application 1304 into a form suitable for transmission to the asset owner 300. The information may then be passed to the Web server 1302 to be transmitted to the asset owner 300 (or, more precisely, to the Web browser 1100 associated with the asset owner 300) as one of the communications messages 1308. For another example, the Web application 1304 may write information to the database management system 1310 in response to communications messages 1308 received from the asset owner 300 or the asset advisor 304 via the Web server 1302. This information may be processed by the Web application 1304 into a form suitable for submission to the database management system 1310, such as and without limitation by embodying the information in the form of an SQL query.

In embodiments, the Web server 1302 and the Web application 1304 may be partially or fully integrated into a single software application or into a suite of software applications.

Referring now to FIG. 14, an alternate embodiment of the advisor/owner server 1102 may, as compared with the exemplary embodiment discussed hereinabove with reference to FIG. 13, additionally comprise a voice server 1400, a voice application 1402, and voice/audio messages 1404. The Voice/Audio messages 1404 may be transmitted and received in the VoiceXML format. The messages 1404 may be directed to and received from the VoIP facility 1204. The voice server 1400 may comprise the Web server 1302, or may comprise a server application specially built to handle data communications in the VoiceXML format. The voice application 1402 may be analogous to the Web application 1304, but may contain alternate logic directed at processing information from the database management system 1310 into a form that is suitably reduced and/or organized so that it may be conveyed in a convenient, spoken form. For example, in response to one of the messages 1404 received via the voice server 1400, the voice application 1402 may extract data from the database management system 1310 and arrange it into a hierarchy of prompts, values, and responses/actions. This hierarchy may comprise a number of prompts to be spoken, expected answers to these prompts, and response values to be spoken or actions to be taken in response to each of the expected answers. This hierarchy may comprise a script directed at providing interactive voice functionality. VoiceXML may be used to embody this hierarchy. The Web service associated with the advisor/owner server 1102 may be provided in whole or in part by the voice application 1402, either operating alone or in conjunction with the Web application 1304.

Referring now to FIG. 15, an exemplary embodiment of the asset broker server 1104 may comprise a database management system 1310 containing a master copy 1500 of the set of asset parameters 312; the Web application 1304; the Web server 1302; and the number of communications messages 1308. The asset broker server 1102 may provide functions associated with or identified as the Web service provided by the asset broker 320, such as trade execution (or execution of the order 324), market making, and other functions related to financial transactions.

In this case, the Web application 1304 may implement functions associated with or identified as the Web service provided by the asset broker 320.

For example, the Web application 1304 may keep current the master copy 1500 of the set of asset parameters 312, such as by updating the master copy 1500 upon the completion of the execution of the order 324. From time to time, the Web application 1304 may publish, transmit, or otherwise disseminate all or part of the master copy 1500 to the advisor/owner server 1102, which may utilize the publication, transmission, or dissemination to update the replica 1300 of the set of asset parameters 312. Maintaining the master copy 1500 and the replica 1300 may, in embodiments, have practical benefits. One such benefit may be enabling some or most of the communications messages 1308 to be directed to the advisor/owner server 1102 instead of the asset broker server 1104. In particular, given that the advisor/owner server 1102 has the replica 1300, it is possible for communications messages 1308 requiring access to the set of asset parameters 312, but not comprising the order 324, to be processed by the advisor/owner server 1102. By limiting the communications messages 1308 received by the asset broker server 1104 to those containing the order 324, the asset broker server 1104 may be able to offer more timely execution of trades than would have been possible if it were responsible for also processing communications messages 1308 not containing the order 324.

Referring now to FIG. 16, an alternate embodiment of the asset broker server 1104 may, as compared with the exemplary embodiment discussed hereinabove with reference to FIG. 15, additionally comprise the voice server 1400, the voice application 1402, and the voice/audio messages 1404. The Web service associated with the asset broker server 1104 may be provided in whole or in part by the voice application 1402, either operating alone or in conjunction with the Web application 1304.

Referring now to FIG. 17, an exemplary embodiment of the event presentation server 1108 may comprise a database management system 1310 containing the calendar events 332; the Web application 1304; the Web server 1302; and the number of communications messages 1308. The event presentation server 1108 may provide functions associated with or identified as the Web service provided by the event presentation facility 334. These functions may be provided as the Web service.

In this case, the Web application 1304 may implement functions associated with or identified as the Web service provided by event presentation facility 334. For example, the Web application 1304 may receive communications messages 1308, via the Web server 1302, of calendar events 332. These messages 1308 may represent additions, modifications, or deletions of such events 332. The events 332 may be processed by the Web application 1304 into a form, such as and without limitation an SQL query, that may be suitable for presentation to the database management system 1310. For another example, the web application 1304 may extract some or all of the calendar events 332 from the database management system 1310 and process these events 332 into a form representative of a day, a week, a month, a year, or some other unit of time. For example, the form may be a day planner suitable for display by the Web browser 1100. This form may be embodied in the HTML format, transferred to the Web server 1302 by the Web application 1304, and then transmitted, broadcast, or disseminated by the Web server 1302 as one of the communications messages 1308. Here, in embodiments and without limitation, the Web application 1304 may comprise Microsoft Access.

Referring now to FIG. 18, an alternate embodiment of the event presentation server 1108 may, as compared with the exemplary embodiment discussed hereinabove with reference to FIG. 17, additionally comprise the voice server 1400, the voice application 1402, and the voice/audio messages 1404. The Web service associated with the event presentation server 1108 may be provided in whole or in part by the voice application 1402, either operating alone or in conjunction with the Web application 1304.

Referring now to FIG. 19, a financial account management process may begin at logical block 1900, from which processing flow may proceed to the RECEIVE ASSET OWNER PARAMETERS 1902 logical block. Here the system may receive asset owner parameters 302. Then, processing flow may proceed to the RECEIVE ASSET ADVISOR PARAMETERS 1904 logical block, where the asset advisor parameters 308 may be received by the system. Next, processing flow may proceed to the RECEIVE ASSET PARAMETERS 1908 logical block, where one or more assets in the set of assets 310 may be registered with the system, such as through the receipt by the system of the set of asset parameters 312. Logical flow may proceed to a logical block 1912, where a test may be conducted to determine if an order should be generated. If the result of this test is affirmative, processing flow may proceed to the GENERATE ORDER 1920 logical block, where the order 324 may be generated by the asset transaction facility 318. From there, processing flow may proceed to the EXECUTE ORDER 1922 logical block, where the asset broker 320 may receive and execute the order. Logical flow may proceed to the test at logical block 1914. However, if the result of the test at logical block 1912 is negative, then processing flow may proceed directly from logical block 1912 to logical block 1914, where a test may be conducted to determine if a calendar event 332 should be generated. If the result of this test is affirmative, then processing flow may proceed to the GENERATE EVENT 1920 logical block, where the asset transaction facility 318 may generate the calendar event 332. From there, processing flow may proceed to the test at logical block 1918. However, if the test at logical block 1914 is negative, then processing flow may proceed directly from logical block 1914 to logical block 1918, where a test may be conducted to determine if an update to the asset advisor parameters 308, the asset owner parameters 302, and/or the asset parameters 312 has been received. If this test result is affirmative, then processing flow may proceed to the UPDATE PARAMS 1920 logical block, where the parameters may be received by the advisor/owner server 1102 and/or the asset broker server 1108, and where the contents of the database management system 1310 may be appropriated updated or modified. Processing flow may then proceed back to the logical block 1912. However, if the test result at logical block 1918 is negative, then processing flow may proceed directly from logical block 1918 to logical block 1912. Referring now to FIG. 20, a financial account management process may begin at logical block 1900, from which processing flow may proceed to the RECEIVE ASSET OWNER PARAMETERS 1902 logical block. Here the system may receive asset owner parameters 302. Then, processing flow may proceed to the RECEIVE ASSET ADVISOR PARAMETERS 1904 logical block, where the asset advisor parameters 308 may be received by the system. Next, processing flow may proceed to the RECEIVE ASSET PARAMETERS 1908 logical block, where one or more assets in the set of assets 310 may be registered with the system, such as through the receipt by the system of the set of asset parameters 312. Processing flow may continue to the test at logical block 2010, where a test may be conducted to determine if the suggestion 500 should be generated. If the result of this test is affirmative, then processing flow may proceed to the GENERATE SUGGESTION 2020 logical block, where the asset transaction facility 318 may generate the suggestion 500. From there, processing flow may proceed to the test at logical block 2030, which may determine whether the recommendation 502 should be generated. If the result of this test is affirmative, then processing flow may proceed to the GENERATE RECOMMENDATION 2032 logical block where the asset broker 320 may generate the recommendation 502. From there, processing flow may continue to the test at logical block 2012. However, if the result of the test at either logical block 2030 or logical block 2010 is negative, then processing flow may proceed directly from those logical blocks to the 2012 logical block. In any case, the test at logical block 2012 may determine whether the calendar event 332 should be generated. If this result of this test is affirmative, then processing flow may proceed to the GENERATE EVENT 2022 logical block, where the asset transaction facility 318 may generate the calendar event 332. From there processing flow may continue to the logical block 2014. However, if the result of the test at logical block 2012 is negative, then processing flow may proceed directly from logical block 2012 to logical block 2014. Logical block 2014 may comprise a test to determine whether an update to the asset advisor parameters 308, the asset owner parameters 302, and/or the asset parameters 312 has been received. If this test result is affirmative, then processing flow may proceed to the UPDATE PARAMS 2024 logical block, where the parameters may be received by the advisor/owner server 1102 and/or the asset broker server 1108, and where the contents of the database management system 1310 may be appropriately updated or modified. Processing flow may then proceed back to the logical block 2018. However, if the test result at logical block 1914 is negative, then processing flow may proceed directly from logical block 1914 to logical block 2018. The test at logical block 2010 may determine whether the order 324 has been received by the asset broker 320. If the result of this test is affirmative, then processing flow may proceed to the EXECUTE ORDER 2028 logical block, where the asset broker 320 may execute the order. From there, processing flow may return to the logical block 2010. However, if the result of the test at logical block 2018 is negative, then processing flow may proceed directly from logical block 2018 to logical block 2010.

Referring now to FIG. 21, a financial account management process may begin at logical block 2100, from which processing flow may proceed to the RECEIVE ASSET OWNER PARAMETERS 2102 logical block. Here the system may receive asset owner parameters 302. Then, processing flow may proceed to the RECEIVE ASSET ADVISOR PARAMETERS 2104 logical block, where the asset advisor parameters 308 may be received by the system. Next, processing flow may proceed to the RECEIVE ASSET PARAMETERS 2108 logical block, where one or more assets in the set of assets 310 may be registered with the system, such as through the receipt by the system of the set of asset parameters 312. Processing flow may continue to the test at logical block 2110, where a test may be conducted to determine if the suggestion 500 should be created. If the result of this test is affirmative, processing flow may proceed to the GENERATE SUGGESTION 2120 where the suggestion 500 may be generated by the asset transaction facility 318. From there processing flow may continue to the test at logical block 2130, where it may be determined whether the recommendation 502 should be created. If the result of this test is affirmative, then the processing flow may continue to the GENERATE RECOMMENDATION 2132 logical block, where the asset advisor 304 may create the recommendation 502 and transmit the recommendation to the asset owner 300. However, if the result of the test at logical block 2130 or logical block 2110 is negative, then processing flow may proceed directly to logical block 2112. Logical block 2112 may comprise a test to determine if the calendar event 332 should be generated. If the result of this test is affirmative, then processing flow may proceed to the generate event 2122 logical block, where the asset transaction facility 318 may generate the calendar event 332. From there processing flow may proceed to the update logical block 2114. However, if the result of the test at logical block 2112 is negative, then processing flow may proceed directly to the test at logical block 2114, which may determine whether an update to the asset advisor parameters 308, the asset owner parameters 302, and/or the asset parameters 312 has been received. If this test result is affirmative, then processing flow may proceed to the UPDATE PARAMS 2124 logical block, where the parameters may be received by the advisor/owner server 1102 and/or the asset broker server 1108, and where the contents of the database management system 1310 may be appropriately updated or modified. From there processing flow may proceed to the 2118 logical block. However, if the result of test at logical block 2114 is negative, then processing flow may proceed directly from there to the test at logical block 2118, which may determine whether the response 600 has been received from the asset owner 300 and whether the response 600 is positive, indicating that the asset owner 300 wishes to comply with the recommendation 502. If the result of this test is affirmative, processing flow may continue to the GENERATE ORDER 2128 logical block, where the asset advisor 304 may generate the order 324. From there, processing flow may continue to the EXECUTE ORDER 2134 logical block, where the asset broker 320 may receive and execute the order 324. Processing flow may then proceed back to the 2110 logical block. However if the result of the test at logical block 2118 is negative, then processing flow may return directly from there to the 2110 logical block.

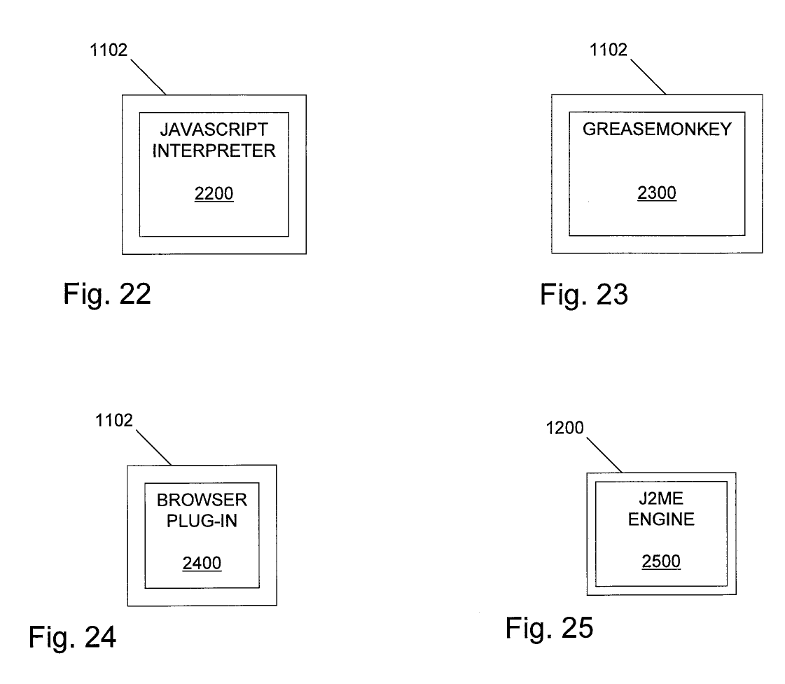

Referring now to FIG. 22, the Web browser 1102 may comprise a technology generally known in the art as a JavaScript interpreter 2200. This may enable the interpretation of software functions that may be embedded in the communications messages 1308. These functions may without limitation be implemented according to a number of software design methodologies known as DHTML, Ajax, and SPA. For example, one software function may provide an interactive presentation of the set of asset parameters 312. Such a presentation may utilize graphical user interface features commonly known as a splitter, a tab, a tree- or hierarchical-view, a grid, a form, a popup, a frame, and the like. Generally, any of the information embodied in the communications messages 1308 may be rendered according to these graphical user interface features utilizing the JavaScript interpreter. For another example, another software function may provide an interactive data entry mechanism, which may allow the user to enter data in an intuitive or rapid manner. Such a mechanism may utilize software features commonly known as tab complete, spell check, autocorrect, auto-suggest, auto-save, find, replace, upcase, downcase, capitalize, underline, emphasize, deemphasize, drag-and-drop, and the like.

Referring now to FIG. 23, the Web browser 1102 may comprise a technology generally known in the art as a Greasemonkey 2300, which may provide a functionally known as active browsing. This technology may enable the Web browser 1102 to actively gather, process, and submit communications messages 1308 from multiple servers 202 according to a JavaScript program provided by the user of the Web browser 1102. This technology may also instruct the Web browser 1102 to render the gathered or processed communications messages 1308 according to the programming of the JavaScript program. In all, Greasemonkey 2300 is fundamentally different from the JavaScript interpreter 2200 in that the JavaScript program according to the Greasemonkey 2300 technology is provided by the user and not the server 202. Thus, with Greasemonkey 2300, the user may augment or modify the behavior of the financial account management system by writing scripts that operate in the Web browser 1102, perhaps automatically, on the user's behalf. It should be apparent that any number of such augmentations or modifications may be possible, and that these augmentations and modifications are to the broadest extent possible to be considered objects of the present invention.

Referring now to FIG. 24, the Web browser 1102 may comprise a technology generally known in the art as a browser plug-in 2400. This technology may enable a compiled computer program to be installed into the Web browser 1102, thus enhancing the built-in features of the Web browser 1102. Unlike the JavaScript programs discussed hereinabove with reference to FIG. 22 and FIG. 23, the browser plug-in 2400 may operate generally at any time the Web browser 1102 is operative, not just when the Web browser 1102 is directed at a particular URL (as may be the case with the JavaScript interpreter 2200 and Greasemonkey 2300). Thus, with the browser plug-in 2400, the features and functions of the financial account management system may be available to the user even when the user is browsing a URL unassociated with the financial account management system. This may enable features such as a real-time quote, a ticker, an instant message capability, an instance alert system, a portal to the features of the financial account management system, a convenient way of interacting with the financial account management system without leaving an unrelated Web page, and so forth.

Referring now to FIG. 25, the telephone 1200 may comprise what is known in the art as a J2ME engine 2500. This may allow the interpretation and/or execution of a compiled program written in the Java language on the telephone 1200. This compiled program, although it may run standalone and not from within the Web browser 1100, may provide functions and features analogous to the functions and features mentioned hereinabove in association with the JavaScript interpreter 2200, Greasemonkey 2300, and the browser plug-in 2400.

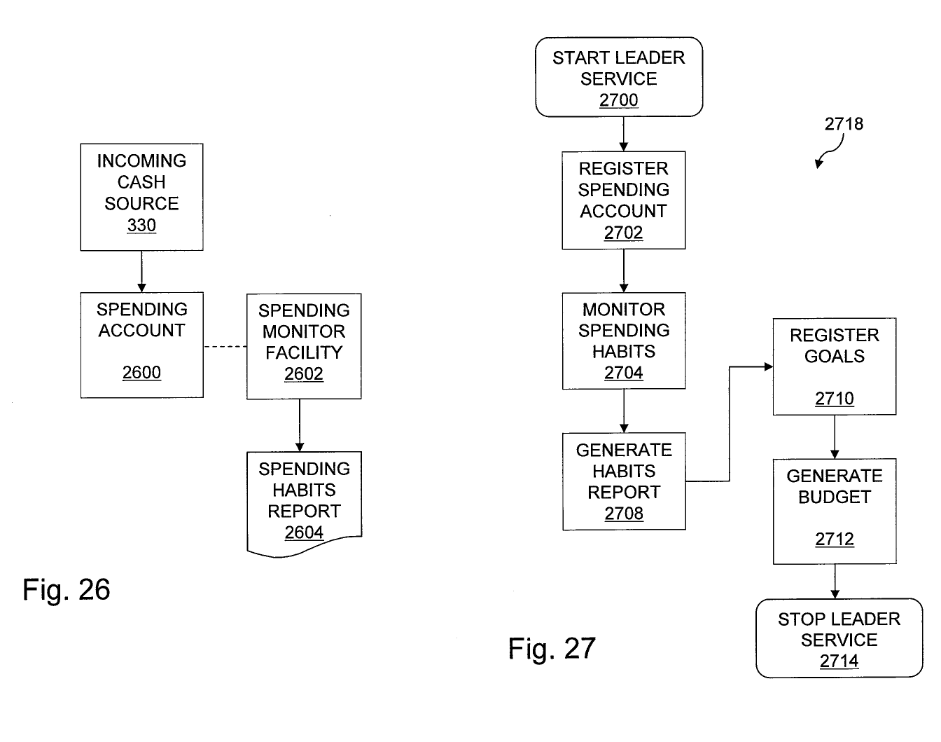

Referring now to FIG. 26, a system for generating a spending habits report 2604 may comprise the incoming cash source 330, a spending account 2600, a spending monitor facility 2602, and the spending habits report 2604. The spending account 2600 may comprise a bank savings account, a bank checking account, a debit card account, a credit card account, a store charge account, or the like. The spending monitor facility 2602, which may be embodied as the server 202, may be associated with the spending account 2600. The incoming cash source 330 may, from time to time, be the source of a deposit of funds into the spending account 2600. The spending account 2600 may be associated with the asset owner 300 who may, from time to time, withdraw money out of the spending account 2600. Over some period of time, the spending monitor facility 2602 may observe the debits and credits charged to the spending account 2600. Data representative of these observed debits and credits observation may be recoded in a database management system 1310. After sufficient data has been gathered, or continuously over time, the spending monitor facility 2602 may generate the spending habits report 2604. The spending habits report 2604 may be in a form directed at human consumption, such as and without limitation a text file, a spreadsheet file, a word processor file, or the like. Alternatively, the spending habits report 2604 may be in a form directed at computer processing, such as the communications message 1308. In any case, the spending habits report 2604 may comprise the observed debits and credits presented in a complete form, in a summarized form, organized dimensionally such as by category of spending, and so forth.

Referring now to FIG. 27, a leader service procedure 2718 is shown for providing a service directed at enticing a person not already associated with the financial account management system to become the asset owner 300. This procedure 2718 may begin at the START LEADER SERVICE 2700 logical block. Logical flow may then proceed to the REGISTER SPENDING ACCOUNT 2702 logical block where the spending account 2600 may be associated with the spending monitor facility 2602. This step may include the creation of the spending account 2600, such as by a financial institution that offers the services of the financial account management system and that is desirous of selling those services to the person not already associated with the financial account management system. Processing flow then proceeds to the MONITOR SPENDING HABITS 2704 logical block, where the spending monitor facility 2602 may observe the debits and credits charged to the spending account 2600. Next, processing flow continues to the GENERATE HABITS REPORT 2708 logical block, where the spending monitor facility 2602 may generate the spending habits report 2604. Then, processing flow may proceed to the REGISTER GOALS 2710 logical block, where the person may provide long-term financial goals (many of which are known in the art) to the financial institution, which may be the asset advisor 304 and/or the asset broker 320. The provision of long-term financial goals may include providing information pertaining to the assets, current liabilities, and long-term liabilities of the person. All of the information provided by the person may be entered into the financial account management system via the Web browser 1100 that is associated with the client 200 of the asset owner 300, in the case that the person is entering the information himself. Or, the information may be entered via the Web browser 1100 that is associated with the asset advisor 304 or the asset broker 320. In any case, the information may be transmitted as the communications messages 1308, received by the advisor/owner server 1102, and stored as the asset owner parameters 302 in the database management system 1310. Following that, processing flow moves to the GENERATE BUDGET 2712 logical block where the asset broker 320 and/or the asset advisor 304 generate and provide a proposed budget to the person. This budget may include suggested savings levels, suggested investments, suggested structure and/or mix of the set of assets 310, suggested spending cuts, projected value of the set of assets 310, comments or alerts relating to the financial health of the person as determined from the SPENDING HABITS REPORT 2604, and so forth. At this point, the person may consider utilize the information in the spending habits report 2604 and associated budget to determine whether or not to become the asset owner 300. In any case, processing flow moves to the STOP LEADER SERVICE 2714 logical block, where the procedure 2718 terminates.

Before discussing particular applications of the financial account management system, the terms “tax-advantaged account” and “tax-aware account” may be understood to encompass a wide range of accounts that have a tax-sensitive component. The term “tax-advantaged account” may refer to a financial account that is subject to particular regulations 1000 that allow for tax-free contributions, tax-free capital gains, or other special tax treatment, perhaps subject to certain limits and restrictions. Common examples of tax-advantaged accounts are the 401(k), the Traditional IRA, the Roth IRA, the SEP IRA, and the like. The term “tax-aware account” may refer to a financial account that may not have an intrinsic tax advantage, but that may contain assets that are managed in a way that is conscious of tax implications. For example, a tax-aware account may be managed in a way that limits realized capital gains for the purpose of limiting taxes to a predetermined level. For another example, a tax-aware account may contain assets, such as municipal bonds, that are selected at least in part because the assets themselves confer a particular tax advantage. Many such tax advantages and management strategies are known in the art. However, by providing the concurrent management of tax-advantaged accounts and tax-aware accounts, tax advantages are produced or maximized that may not otherwise be possible. Moreover, the automatic nature of the concurrent management provided by the present invention may allow for greater efficiency in the delivery of financial account management services than would otherwise be possible. The present invention may encourage people to save for retirement by creating an organized system for both saving and investing; and may help Baby Boomers cope with the required deductions after retirement which, according to some regulations 1000, may carry penalties as high as 50% of the amount of the distribution.

One embodiment of the financial account management system may provide a paired retirement savings system in which cash from the incoming cash source 330 may be automatically deposited into one or more tax-advantaged accounts, each of which may be paired with a tax-aware account. In all, the set of assets 310 may comprise the accounts. If the asset owner 300 has only two accounts and these accounts are at the same financial services bank, mutual fund firm, brokerage firm, or other financial services institution, or under the same financial services umbrella, then the accounts may be managed together as a pooled fund and in an especially cost-efficient manner. If the asset owner 300 has additional accounts, in some instances and perhaps as directed by the asset transaction facility 318 that may be rolled over and/or consolidated into the pooled fund. In other instances, the additional accounts may not be rolled over and/or consolidated. In this case, as needed, the additional accounts are paired with a matching account. In other words, every tax-aware account must be paired with a tax-advantaged account. It is possible for a tax-aware account to be paired with multiple tax-advantaged accounts. In some cases, the pairing may necessitate the creation of a new account. In any case, the financial institution, which may be the asset advisor 304 and/or the asset broker 320, may set up as many paired accounts as is appropriate for the basic types of tax-advantaged accounts such as IRA's and 401(k)'s. In some embodiments, there may be a three to five year period in which new assets from the incoming cash source 330 are allocated to a tax-aware account that is designated a “transition account.” Capital gains resulting from sales of assets in the transition account may be capped at a percent per year that has been pre-approved by the asset owner 300 during the leader service procedure 2718. Upon the asset owner's 300 reaching retirement, the financial account management system may automatically deduct the minimum required distribution (MRD's) from every tax-advantaged account in the set of assets 310 and deposits it into the appropriate paired tax-aware account.

The asset owner 300 may create or modify the asset owner parameters 302 during the leader service procedure 2718, or at any time thereafter. The asset owner 300 may create, modify, or delete the asset owner parameters 302 prior to or during retirement. The asset owner parameters 302 may comprise a unique identification number, which may be used as a primary key identifying the asset owner parameters 302. Access to the asset owner parameters 302 may be controlled, such as via a password, an answer to a secret question, a personal identification number, a biometric scan, or any other such method. The controlled access may allow read-only access to the parameters 302 to some entities, while other entities may have read-write access, write-only access, or no access. One goal of the controlled access may be to limit access to the parameters 302 to only the asset owner 300 or a legal representative of the asset owner 300.

Another embodiment of the financial account management system may provide the asset owner 300 with a service that customized by the asset owner 300 on the basis of a two to five year budget that is provided to the financial account management system at the time the asset owner 300 begins utilizing the system's services. This budget, of which the asset owner parameters 302 may be comprised, may include a schedule of expected cash deposits and a schedule of expected cash withdrawals. These schedules may be used as the basis of a short-term investment plan, which may in whole or in part be automatically determined by the asset transaction facility 318 and may be embodied as the asset allocation rules 402. The asset allocation facility may automatically generate orders 324 directed at investing in one or more fixed-income investment vehicles of appropriate length to maintain a balanced set of short-term investments in the set of assets 310. The financial account management system may generate a periodic (such as annual) e-mail, text message, instant message, alert, notification, or other form of communication to remind the asset owner 300 to update the asset owner parameters 302. This annual reminder may direct the asset owner to call, visit a Web site, send an e-mail, or somehow cause affect the creation and transmission of one of the communications message 1308 directed at updating the asset owner parameters 302. This update of the asset owner parameters 302 may result in a change in the allocation and/or liquidity of the set of assets 310.

Yet another embodiment of the financial account management system may provide for the management of the set of assets 310 in a manner that is directed toward long-term, non-retirement savings. This savings may be associated with the future purchase of a vacation home or any other major, future outlay. In this embodiment, one of the asset owner parameters 302 may specify a risk tolerance, such as conservative, medium, or high risk. The set of assets 310 under management in this embodiment be expected to be spent by the asset owner 300 within a period of twenty years, more or less. To consolidate the asset owner's 300 overall long-term investing, especially if the set of assets 310 are not sold as anticipated, the set of assets 310 may be linked to a tax-aware account, perhaps resulting in that tax-aware account being linked to both the long-term non-retirement savings account and to the previously linked tax-advantaged account. In any case, the process of selling an asset in the set of asset 310 and transferring the proceeds to the outgoing cash account 328 (or into a short-term savings account of which the set of assets 310 may be comprised) may proceed as follows: The asset owner 300 may utilize the Web browser 1100 provided by the client 200 associated with the asset owner 300. This Web browser 1100 may provide a form or other graphical user interface capable of accepting input from the asset owner 300, as may be made possible by HTML, JavaScript, Greasemonkey, a browser plug-in, or something of the like. The asset owner 300 may enter information into the graphical user interface at time an account associated with the asset is created or any time thereafter. This information, of which the asset owner parameters 302 may be comprised, may designate the times at which sales of the asset should be made and amounts of cash that will be needed.

In another embodiment, the financial account management system may produce one or more orders 324 to sell assets that minimize capital gains while simultaneously providing sufficient proceeds to the asset owner 300.

In yet another embodiment, the financial account management system may issue a communications message 1308 directed to the asset owner 300 prior to the execution and/or issuance of the order 324 to sell one of the set of assets 310. This message 1308, which may comprise the recommendation 502, may be transmitted a number of days or months ahead of the recommended sale. To prevent the recommended sale from occurring, depending upon the particular embodiment of the system, the asset owner 300 may either issue the appropriate response 600 or not issue the order 324. The appropriate response 600 may comprise the unique identification number. The appropriate response 600 may be issued by the asset owner 300 to the financial account management system via the Web browser 1100 and/or the telephone 1200. If, however, the sale does occur, proceeds from the sale may be transferred into the outgoing cash account 328 in anticipation of instructions for distributing the proceeds out of the system. Or, the proceeds may be transferred into a short-term savings account of which the set of assets 310 may be comprised.

In still yet another embodiment, the financial account management system may allow the asset owner 300 to conduct a financial analysis on the set of assets 310 without input or influence from the asset advisor 304 or the asset broker 320. The system may provide the asset owner 300 with a menu of options from which may be directed at asset allocation or business/financial sector related to investments. These options may comprise free options and options that are provided for a fee by the financial account management system or a third party. The financial analysis and/or menu of options may be provided by or via the asset review facility 700.

In another embodiment, the financial account management system may receive feeds from Web sites. The content of these feeds may affect the presentation of set of assets 310 by the asset review facility 700. In one example, the set of assets 310 may be sorted by financial performance over the past 24 hours as determined by information received in the feeds. Many other examples will be apparent.

In still another embodiment, the financial account management system may be referred to as the “master financial account management system” and may direct the operation of one or more other financial account management systems and/or one or more instances of the financial account management system. In this case, the asset broker 320 of the master financial account management system may be one or more instances of the financial account management system. These one or more instances may inherit the asset owner 300, but may or may not inherit the asset advisor 304. The set of assets 310 managed by these one or more instances may be a subset of the set of assets 310 managed by the master financial account management system. Thus, all of these financial account management systems may be arranged hierarchically, with the top-level financial account management system being the master financial account management system. From the perspective of the asset owner 300, who may interact solely with the master financial account management system, this arrangement may allow for the collective viewing, but independent management, of the investments of which the set of assets 310 may be comprised.

Generally, the asset owner parameters 302 may comprise the unique identifier associated with the asset owner 300, a tax-advantaged account number, a tax-aware account number, a short-term account number, a long-term account number, a retirement account number, a non-retirement account number, a unique identifier associated with rules or other parameters affecting a specific paring of accounts, and the like. When grouped together, the unique identifier associated with the rules or other parameters and those rules or other parameters themselves may collectively be referred to as a “spigot.” This metaphorical reference evokes an image of cash flowing into a uniquely identifiable spigot on one side and flowing out of the spigot into a plurality of assets on the other side, with the spigot regulating the proportion of the total flow that reaches each one or more of the plurality of assets.

In one embodiment, a spigot may be directed at (1) receiving cash from the incoming cash account 332; (2) directing the cash first to the tax-advantaged and tax-aware accounts in the set of assets 310; (3) keeping track of tax-advantaged accounts reaching their annual maximum contribution limits; (4) properly directing the cash to the accounts in an order of priority optionally set by the asset owner 300; and (5) ensuring that all minimum required distributions are automatically made from all tax-advantaged accounts and transferred to the paired tax-aware account (or according to other standing instructions that may be stored as the asset owner parameters 302, the asset advisor parameters 308, or the asset parameters 312).

In another embodiment, a spigot may be directed at (1) receiving cash from the incoming cash account 332 and allocating it to the proper investment vehicle according to a software budget plan such as the asset allocation rules 402; and (2) channeling sales proceeds from accounts managed for long-term savings into accounts managed for short-term savings and/or into the outgoing cash account 328.

In yet another embodiment, a spigot may additionally or optionally be directed by the asset advisor 304 via modification the asset advisor may make to the asset advisor parameters 308. The asset advisor 304 may be associated with a financial services firm that is managing the set of assets 310. The asset advisor parameters 308 (and, for that matter, the asset owner parameters 302) may provide an override or master-control mechanism over the spigot, allowing in essence the action of the spigot to be manually or externally operated. In association with the management of the spigot, the asset advisor 304 may communicate with the asset owner 300 via any means provided by the financial account management facility. The asset advisor 304 may also cause the asset transaction facility 318 to issue an order 324 directly to the asset broker 320, perhaps according to the response 600 of the asset owner 300.

In still yet another embodiment, a spigot may be directed at allocating deposits among investments in cash, those maturing in 3 months, 6 months, 1 year, 2 years, 3 years, 4 years and 5 years to provide constant liquidity and eliminate the need for the asset owner 300 to constantly rollover investment vehicles such as CD's and treasury bills and bonds.

In another embodiment, a spigot may be directed at removing, from time to time, money from the set of assets 310 and depositing the money in the outgoing cash account 328.

In still another embodiment, a spigot may be directed at providing a certain level of liquidity in the set of assets 310.

In yet another embodiment, a spigot may be subject to override by the asset owner parameters 302, the asset advisor parameters 304, and/or the set of asset parameters 320.

In one embodiment, there may be a plurality of incoming cash sources 330 associated with one or more incoming cash accounts 322, all of which may be used as a source of funds by the asset broker 320.

In another embodiment, a spigot may be directed at implementing a blend of short-term, long-term, and estate planning goals. In one instance of this embodiment, the set of assets 310 may comprise a revocable trust, a charitable lead trust, a short-term investment account, a long-term investment account, an perhaps one or more tax-advantaged retirement accounts.

In still another embodiment, a spigot may be directed at allocating funds from the incoming cash account 322 into a college savings account, such as and without limitation a UTMA, an education IRA, or §529 education account.

In another embodiment, a spigot may be directed at depositing short-term savings into a checking account.

In yet another embodiment, a spigot may be directed at depositing short-term savings into a credit card account, which may be used for a big-ticket purchase, such as to pay for college tuition, with the aim of accumulating significant frequent flier miles or retirement account rebate dollars due to particular credit card promotions.

In still another embodiment, a spigot may be directed at providing a distribution as an annual exclusion gift.

In another embodiment, a spigot may be directed at providing a gift for the purpose of creating an income tax deduction.

In still another embodiment, a spigot may be directed at allocating funds from a revocable trust into a long-term savings account and then into a Q-TIP and/or by-pass trust after the death of the asset owner 300, with the aim of taking advantage of estate tax exemptions.

In another embodiment, a spigot may be directed at a divorce settlement or other division of assets.

In still another embodiment, a spigot may be disabled due to a pending legal outcome.

In yet still another embodiment, a spigot may be directed at supporting alimony payments and/or child support payments.

In another embodiment, a spigot may be directed at consolidating the assets of two individuals in association with a marriage of the individuals to one another.

In yet another embodiment, a spigot may be responsive to a loss of employment by the asset owner 300.

In yet still another embodiment, the asset owner 300 may comprise a parent or grandparent and the set of assets 310 may comprise one or more college savings accounts. Here, the asset transaction facility 318 may direct the management of the set of assets 310 in a manner that provides a specified or calculated level of funding to the one or more college savings accounts while, perhaps, simultaneously providing additional functions as described throughout this disclosure.

In another embodiment, the asset owner 300 may be more broadly defined to include a will, a trust, or some other facility providing instructions and/or direction for the management of the set of assets 310 associated with said facility. In this case, an executor, trustee, or other official or delegate associated with the asset owner 300 may act on behalf of the asset owner 300, as the asset owner 300, and/or under the direction of the asset owner 300. In this embodiment, the asset owner parameters 302 may comprise the age of a person creating the will, trust, or other facility; the age of the a spouse of this person; the number of dependents of the person; the number of grandchildren of this person; the benefactors of this person; and the like.

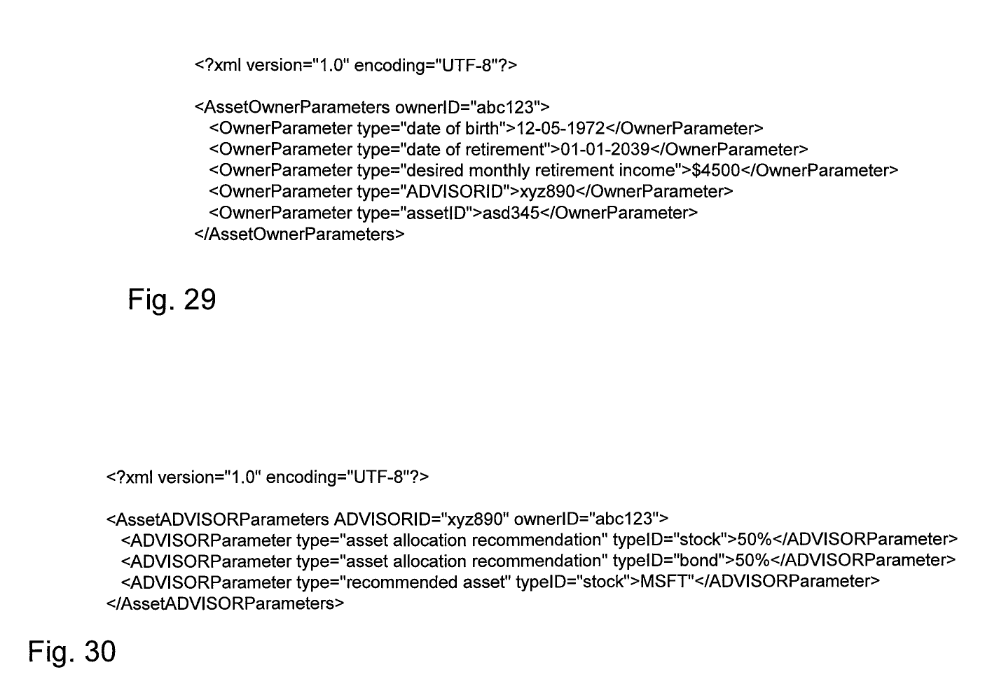

Referring now to FIG. 29, an embodiment of the asset owner parameters 302 may comprise the depicted XML file comprising one AssetOwnerParameters element containing a number of OwnerParameter elements. The AssetOwnerParameters element contains an ownerID parameter, which may be associated with the asset owner 300 and may be unique. The OwnerParameter elements contain the parameters “date of birth,” “date of retirement,” “desired monthly retirement income,” “advisorID,” and “assetID.” The contents of these elements may correspond to the birth date of the asset owner 300, the date of retirement of the asset owner 300, the desired monthly retirement income of the asset owner 300, a unique identification code associated with the asset advisor 304 associated with the asset owner 300, and a unique identification code associated with the set of assets 310 associated with the asset owner 300.

Referring now to FIG. 30, an embodiment of the asset advisor parameters 308 may comprise the depicted XML file comprising an AssetAdvisorParameters element containing a number of AdvisorParameter elements. The AssetAdvisorParameters element contains an advisorID parameter, which may be associated with the asset advisor 304 and may be unique. The AssetAdvisorParameters element also contains the ownerID parameter. The purpose of these two parameters may be to identify this particular AssetAdvisorParameters as being those created and/or managed by the specified asset advisor 304 in association with the specified asset owner 300. The AdvisorParameter elements contain type and typeID parameters. The AdvisorParameter indicated as containing an asset allocation recommendation of type stock may provide a target, specified in terms of percentage of total assets, that the asset advisor 304 recommends for the allocation of stock in the set of assets 310 associated with the asset owner 300. The AdvisorParameter indicated as containing an asset allocation recommendation of type bonds may provide a target, specified in terms of percentage of total assets, that the asset advisor 304 recommends for the allocation of bonds in the set of assets 310 associated with the asset owner 300. The AdvisorParameter indicated as containing a recommended asset of type stock may provide a recommendation, specified in terms of a stock ticker symbol, that the asset advisor 304 recommends to be included in the allocation of stock in the set of assets 310 associated with the asset owner 300.

Referring now to FIG. 31, an embodiment of the set of asset parameters 312 may comprise the depicted XML file comprise an AssetParameterSet element containing a number of AssetMetadata elements, which themselves contain Metadatum elements. The AssetParameterSet element contains an assetID parameter, which may be associated with the set of assets 310 any may be unique. The AssetMetadata elements contain accountInsitution parameters and accountID parameters, the values of which may identify the financial institution and account number, respectively, that may be associated with a particular financial account in the set of assets 310. The Metadatum elements contain type parameters, the values of which may serve to classify the contents of the elements. In this example, the set of asset parameters 312 indicates that the set of assets 310 comprises a traditional IRA account at Fidelity and a savings account at Bank of America. The traditional IRA has an associated account number (expressed as the value of the parameter accountID) and a contribution cap per annum of $10000. The savings account also has an accountID, but its metadata pertains to the current cash value of the savings account and the minimum balance of the account.

With respect to the foregoing examples of embodiments involving XML files and referring to FIG. 29, FIG. 30, and FIG. 31, it should be clear to those of ordinary skill in the art that these are merely particular examples of embodiments and that perhaps an incalculable number of alternate embodiments are possible. It should likewise be apparent these example include but a few of the possible elements and values of which the asset owner parameters 302, the asset advisor parameters 308, and the set of asset parameters 312 may be comprised. These examples embodiment are provided for the purpose of illustration and not limitation.

Referring now to FIG. 32, a screenshot of one embodiment of the presentation facility 334. Here, one day of a calendar is shown. A day planner view appears in the left column and a to-do list appears in the right column. In addition to events and to-do's that may have been entered using a system other than the financial account management system, there appear two items that may be a rendering of the calendar event 332. The first is the alert 3200, conveying information pertaining to a financial transfer conducted by the financial account management system. The second is the to-do item 3202, that conveys high-level information pertaining to an adjustment to the allocation of the set of assets 310 followed by a hyperlink 3204 which, if selected, may result in the display of detailed information, perhaps via a Web page, that is associated with the high-level information. It should be appreciated that this screenshot represents just one snapshot of one embodiment of the presentation facility 334 and that, in practice, numerous snapshots and numerous embodiments are possible. Also, it should be appreciated that any calendar event 332, not just those depicted, may be rendered by the presentation facility 334.

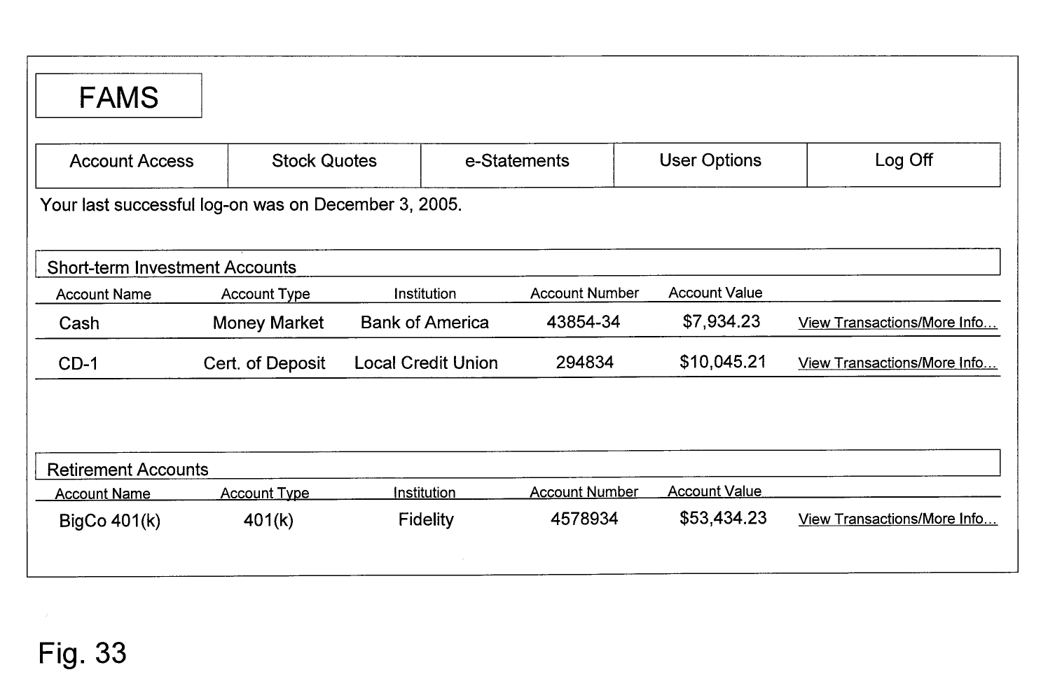

Referring now to FIG. 33, a screenshot of one embodiment of the rendition 702 is provided. As shown, the asset owner 300 has already provided a username and password to the asset review facility 700. This screenshot shows that asset owner's 300 last successful log-on to the asset review facility 700 as on Dec. 3, of 2005. Above this indication is a row of hyperlinks labeled “Account Access,” “Stock Quotes,” “e-Statements,” “User Options,” and “Log Off.” Many such hyperlinks are known in the art to be associated with financial management Web pages or graphical user interfaces and all such hyperlinks are intended to fall within the scope of this invention. A label, “Short-term Investment Accounts,” delimits the top of a section of the screenshot in which may be presented information pertaining to short-term investment accounts in the set of assets 304. In this example, two accounts are shown, named “Cash” and “CD-1,” respectively. The types of these accounts, the financial institution associated with the accounts, the account numbers, and the account values of the accounts are clearly shown. In addition, each account is associated with a hyperlink labeled “View Transactions/More Info . . . ” which, when selected, may provide more detailed information pertaining to the account with which the hyperlink is associated. Another label, “Retirement Accounts,” delimits the top of a section of the screenshot in which may be presented information pertaining to long-term investment accounts in the set of assets 304. In this example, one account is shown, named “BigCo 401(k).” The type of this account, the financial institution associated with the account, the account's number, and the account's value are clearly shown. An instance of the “View Transactions/More Info . . . ” hyperlink is associated with this account. A feature of this invention may be that accounts from a plurality of financial institutions may be displayed on one screen and may be subject to coordinated management the financial account management system.

While the invention has been disclosed in connection with certain preferred embodiments, other embodiments will be recognized by those of ordinary skill in the art, and all such variations, modifications, and substitutions are intended to fall within the scope of this disclosure. Thus, the invention is to be understood with reference to the following claims, which are to be interpreted in the broadest sense allowable by law.

What is claimed is:

1. A method of handling financial assets designated by an entity, comprising:
taking a first asset facility designated by the entity;
taking a second asset facility designated by the entity; and
allocating a financial asset among the first asset facility and the second asset facility based on a condition, wherein the first asset facility and the second asset facility are maintained by separate financial institutions.

2. A method of claim 1, wherein the condition is set via a Web browser.

3. A method of claim 2, wherein the Web browser utilizes a plug-in.

4. A method of claim 2, wherein the Web browser utilizes a toolbar.

5. A method of claim 2, wherein the Web browser utilizes Ajax.

6. A method of claim 2, wherein the Web browser utilizes Greasemonkey.

7. A method of claim 2, wherein the Web browser utilizes a JavaScript interpreter.

8. A method of claim 2, wherein the Web browser is on a mobile facility.

9. A method of claim 8, wherein the mobile facility is a cell phone.

10. A method of claim 8, wherein the mobile facility is a personal digital assistant.

11. A method of claim 10, wherein the personal digital assistant is a Blackberry.

12. A method of claim 8, wherein the mobile facility utilizes a J2ME engine.

13. A method of claim 1, wherein the condition is set via a mobile facility.

14. A method of claim 13, wherein the mobile facility is a cell phone.

15. A method of claim 13, wherein the mobile facility is a Blackberry.

16. A method of claim 13, wherein the mobile facility is a personal digital assistant.

17. A method of claim 13, wherein the mobile facility utilizes a J2ME engine.

18. A method of claim 1, wherein allocating is performed in response to data entered a Web browser.

19. A method of handling financial assets designated by an entity, comprising: taking a first asset facility designated by the entity;
taking a second asset facility designated by the entity; and
allocating a financial asset among the first asset facility and the second asset facility based on a condition, wherein the allocation is based on a network-based allocation technology.

20. A method of handling financial assets designated by an entity, comprising:
taking a first asset facility designated by the entity;
taking a second asset facility designated by the entity; and
allocating a financial asset among the first asset facility and the second asset facility based on a condition, wherein the first asset facility is tax-aware and the second asset facility is tax-advantaged.
